(19) United States
(12) Patent Application Publication
(10) Pub. No.: US 2023/0004686 A1
(43) Pub. Date: Jan. 5, 2023

(54) Optimization of Geometry of Shaped Body and Manufacturing Tools

(71) Applicant: BASF SE, Ludwigshafen (DE)

(72) Inventors: Marcelo Daniel Kaufman Rechulski, Antwerpen (BE); Miguel Angel Romero Valle, Ludwigshafen (DE); Stefan Lipp, Ludwigshafen (DE); Marco Oskar Kennema, Ludwigshafen (DE); Matthias Johannes Wagner, Ludwigshafen (DE)

(21) Appl. No.: 17/779,780

(22) PCT Filed: Nov. 26, 2020
(86) PCT No.: PCT/EP2020/083493

§ 371 Date: May 25, 2022

(30) Foreign Application Priority Data
Nov. 26, 2019 (EP) 19211571.5

(51) Int. Cl. G06F 30/10; G06F 30/27

(52) U.S. Cl. CPC G06F 30/10; G06F 30/27

(57) ABSTRACT

A computer-implemented method (110) for designing at least one shaped body (112), a computer-implemented method (138) for designing a manufacturing process for manufacturing at least one shaped body (112), a designing system (152) for designing at least one shaped body (112) and a manufacture-designing system for designing a manufacturing process for manufacturing at least one shaped body (112). The computer-implemented method (110) for designing at least one shaped body (112) comprises: a) retrieving, by using at least one interface (154), at least one set of target criteria for the shaped body (112); b) defining, by using at least one geometry defining unit (156), at least one seed geometry for the shaped body (112); c) generating, by using at least one parameter generating unit (158), a set of parameters comprising at least one geometry parameter of the seed geometry; d) simulating, by using at least one simulation unit (160), the shaped body by varying values of the set of parameters and by corn-paring simulated criteria for these values with the set of target criteria, thereby generating at least one adapted set of parameters for which the target criteria are fulfilled at least within predetermined tolerances; and e) determining, by using at least one lead candidate geometry defining unit (162), at least one lead candidate geometry of the at least one shaped body (112) from the adapted set of parameters.

### TECHNICAL FIELD

The invention relates to a computer implemented method for designing at least one shaped body, to a computer implemented method for designing at least one shaping tool, to a computer implemented method for designing a manufacturing process for manufacturing at least one shaped body, a computer program for designing at least one shaped body, a computer program for designing at least one die, a designing system for designing at least one shaped body, a die designing system for designing at least one shaping tool and a manufacture-designing system for designing a manufacturing process for manufacturing at least one shaped body. The methods, computer programs and systems according to the present invention specifically may be used for designing a shaped body, such as for example catalyst geometries or geometries of catalyst shaping tools. However, further and/or other applications are feasible.

### BACKGROUND ART

The designing of components and parts is a central aspect of development processes performed in small and large scale manufacturing and/or producing industry. Specifically, in chemical industry, the designing of a shape of steam reforming catalysts is a conventionally performed procedure, typically aiming at improving catalyst performance. Thus, in general, a complex and elaborate designing of the shape of steam reforming catalysts is performed. Thus, in “Optimum dimensions of shaped steam reforming catalysts” by Kagyrmanova et al. published in the chemical Engineering Journal 134 (2007) 228-234 a theoretical optimization of shaped catalyst dimensions with technologically imposed constraints for operating conditions of a typical methanol reformer is described. Further, in “Catalyst shape as a design parameter—optimum shape for methane-steam reforming catalyst” by Soltan Mohammadzadeh and Zamaniyan published by the Institution of Chemical Engineers Trans IChemE, Vol 80, Part A in May 2002, a mathematical model for simulation of a catalytic terrace wall methane-steam reformer has been developed. Further, in “Multi-objective shape optimization of a heat exchanger using parallel genetic algorithms” by Hilbert R et al. published in the International Journal of Heat and Mass Transfer 49 (2006) 2567-1577 a design optimization concerning the blade shape of a heat exchanger using a genetic algorithm is disclosed. Therein, a procedure to find the geometry most favorable to simultaneously maximize heat exchange while obtaining a minimum pressure loss is described. Further, in “Multi-objective optimization of microchannel reactor for Fischer-Tropsch synthesis using computational fluid dynamics and genetic algorithm” by Na Jonggeol et al. published in the Chemical Engineering Journal 313 (2017) 1521-1534 a multi-objective optimization methodology for simultaneously maximizing C₅₊ productivity and minimizing the temperature rise of a Fischer-Tropsch microchannel reactor. The methodology is applied to the catalyst packing zone division, which is divided and packed with a different dilution ratio to distribute the heat of reaction evenly.

Further, in general, shape optimization is performed in multiple development processes. As an example, US 2016/0004793 A1 describes a method for analysis of shape optimization including: setting, as a design space, a portion to be optimized in a movable portion; generating, in the set design space, an optimization block model formed of three-dimensional elements and is to be subjected to analysis processing of optimization; connecting the generated optimization block model with a structural body model; setting a material property for the optimization block model; setting an optimization analysis condition for finding an optimum shape of the optimization block model; setting a multi-body dynamics analysis condition for performing multi-body dynamics analysis on the structural body model with which the optimization block model has been connected; and executing, based on the set optimization analysis condition, the multi-body dynamics analysis on the optimization block model and finding the optimum shape of the optimization block model.

US 2007/0050068 A1 describes an optimization method for optimizing a shape of a component including the steps of setting information including a shape of each part in the component to plural parameters, extracting a relationship between the plural parameters and a deformation of the component, changing a value of at least one of the plural parameters so as to reduce a deformation of the component, and adjusting a volume of the component.

In US 2003/0083763 A1 a method and a device enabling any operator even without skill to efficiently, constantly determine an optimum packaging specification of vehicle parts, or the like, is described. Therein, various factors possibly damaging articles are presets as protective properties, and at least one of the protective properties is determined for a particular article based on its surface materials, longest size of its dimensions and its weight. Based on the protective property determined, at least one of packaging materials classified in property is determined for packaging the article, then a packaging form is determined from the determined packaging material and the article property, and a packaging order of the determined packaging form is determined according to packaging priorities preset for such packaging forms.

Further, U.S. Pat. No. 7,477,955 B2 describes an object, enabling provision of an optimum shape design method in which an optimum shape of a cushioning material used in cushioning packaging can easily and adequately be designed, and an optimum shape design system in which the optimum shape design method is used.

U.S. Pat. No. 8,938,974 B1 describes a method for determining the optimum inlet geometry of a liquid rocket engine swirl injector including obtaining a throttleable level phase value, volume flow rate, chamber pressure, liquid propellant density, inlet injector pressure, desired target spray angle and desired target optimum delta pressure value between an inlet and a chamber for a plurality of engine stages. The method calculates the tangential inlet area for each throttleable stage. The method also uses correlation between the tangential inlet areas and delta pressure values to calculate the spring displacement and variable inlet geometry of a liquid rocket engine swirl injector.

Further, in DE 103 42 147 B4 a process for automatically calculating a deformation compensating geometry for a forming tool is described. The process comprises determining the starting geometry and altering it according to the deviation from a threshold value. The starting geometry is approximated by surface elements, and junction points are determined for each element. The difference vector for each starting point is calculated, along with an average vector, and the junction point is moved about the average vector. The surface elements are triangles.

However, constantly evolving manufacturing possibilities require alterations in the developing process of manufacturing processes. Thus, in designing components and manufacturing processes several technical challenges exist. Typically, in every phase of the developing process, specifically when designing and creating geometries of components and parts, input from technical experts is required, such as in the field of mechanical engineering, chemical engineering, chemistry, material sciences or physics, e.g. for constructing and interpreting models, simulations and calculations. In particular, designing methods and systems require the performance of complex calculations and intensive computing. Generally, designing methods and systems comprise iterative processes, wherein it is required to iteratively adapt calculations, models and simulations. Thus, generally, the performing of such methods is very time-consuming, costly and complex.

### Problem to be Solved

It is therefore desirable to provide means and methods which address the above mentioned technical challenges of designing components and parts, such as shaped bodies and dies, or manufacturing processes for manufacturing such components. Specifically, methods computer programs and systems shall be proposed for improving the process of designing at least one shaped body or shaping tool, e.g. a die, and their respective manufacturing processes, compared to methods, computer programs and systems known in the art.

### SUMMARY

This problem is addressed by the methods, computer programs and systems of the independent claims. Advantageous embodiments which might be realized in an isolated fashion or in any arbitrary combination are listed in the dependent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the invention a computer-implemented method for designing at least one shaped body is disclosed. The computer-implemented method may also be referred to as method, design method or designing method. The computer-implemented method comprises the following steps, which may be performed in the given order. However, a different order may also be possible. Further, one or more than one or even all of the steps may be performed once or repeatedly. Further, the method steps may be performed in a timely overlapping fashion or even in parallel. The method may further comprise additional method steps which are not listed.

The computer-implemented method for designing at least one shaped body comprises the following steps:
a) retrieving at least one set of target criteria for the shaped body;
b) defining at least one seed geometry for the shaped body;
c) generating a set of parameters comprising at least one geometry parameter of the seed geometry;
d) simulating the shaped body by varying values of the set of parameters and by comparing simulated criteria for these values with the set of target criteria, thereby generating at least one adapted set of parameters for which the target criteria are fulfilled at least within predetermined tolerances; and
e) determining at least one lead candidate geometry of the at least one shaped body from the adapted set of parameters.

The method for designing at least one shaped body may be used for designing at least one catalyst, specifically a catalyst pellet, e.g. a geometry of at least one catalyst and/or catalyst pellet. In particular, e.g. alternatively or additionally, the method for designing at least one shaped body may be used for designing at least one adsorbent, specifically an adsorbent pellet, e.g. a geometry of at least one adsorbent and/or adsorbent pellet. Additionally or alternatively, the method for designing at least one shaped body may be used for designing at least one particle and/or at least one extrudate, e.g. at least one tablet and/or agglomerate. The method for designing at least one shaped body may be used for designing at least one shaped body to be produced and/or manufactured at least partially in a granulation process and/or tableting process and/or in an extrusion process. As a further example, the shaped body may be produced and/or manufactured at least partially in an aggregation process, in an additive or subtractive manufacturing process, a spray drying process, a coating process, an impregnation process, a 3D-printing process. Other manufacturing processes may be possible, such as for example catalyst manufacturing processes, e.g. as described in “Handbook of Heterogeneous Catalysis” by Schüth et al. second, completely revised and enlarged edition, volume 1, p. 680-698. Specifically, as an example, the shaped body may be used for separation processes additional to adsorption, such as distillation, gas scrubbing and/or gas stripping, or the like.

The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processor. The term “computer”, thus, may generally refer to a device or to a combination or network of devices having at least one data processing means such as at least one processor. The computer, additionally, may comprise one or more further components, such as at least one of a data storage device, an electronic interface or a human-machine interface.

The term “processor” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise one or more application-specific integrated circuits (ASICs) and/or one or more field-programmable gate arrays (FPGAa) or the like.

The term “designing” as used herein is a broad term and is to be given its ordinary and customary meaning to a person of ordinary skill in the art and is not to be limited to a special or customized meaning. The term specifically may refer, without limitation, to a procedure of planning and/or specifying an object or process. The procedure of designing, as an example, may comprise developing and/or defining at least one property of the object or process.

The term “designing at least one shaped body” as used herein is a broad term and is to be given its ordinary and customary meaning to a person of ordinary skill in the art and is not to be limited to a special or customized meaning. The term specifically may refer, without limitation, to a procedure of planning and/or specifying at least one shaped body. In particular, the designing of at least one shaped body may specifically be or may comprise developing and/or defining at least one property of the shaped body, such as, for example, a geometry and/or a shape of the shaped body.

The term “shaped body” as used herein is a broad term and is to be given its ordinary and customary meaning to a person of ordinary skill in the art and is not to be limited to a special or customized meaning. The term specifically may refer, without limitation, to an arbitrary part or component having a predefined form or shape. In particular, the shaped body may be or may comprise at least one component or part to be manufactured in a large-scale, e.g. configured to be produced in large quantities such as in multiple numbers. Specifically, the shaped body may be produced or manufactured in a quantity ranging from 20 to 20000000 pieces per hour, preferably from 100 to 1000000 pieces per hour, more preferably from 1000 to 400000 pieces per hour. In particular, the shaped body may be produced or manufactured in a quantity ranging from 1 to 100000 kg per hour, preferably from 5 to 50000 kg per hour, more preferably from 50 to 20000 kg per hour. Thus, as an example, the shaped body may be configured to be produced or manufactured by one or more of an extrusion process and a tableting process, such as by using an extrusion machine or a tableting machine.

Specifically, the shaped body may be configured to be produced and/or manufactured by at least one of an extrusion process and a tableting process. However, parallel production, such as parallel production and/or manufacturing of the shaped body by more than one extrusion and/or tableting process may be possible. In particular, the above-mentioned manufacturing quantity for the shaped body may be valid for one extrusion process and/or one tableting process, specifically for one production unit, such as for one extruder of the extrusion process or for one press of the tableting process. Thus, as an example, the manufacturing quantity may multiply according to a number of production units used for production, such as according to the number of extruders and/or presses used in parallel within the extrusion process and/or the tableting process.

As an example, the shaped body may be or may comprise a molded body and/or a molded part, such as an object and/or component generated by making use of at least one forming process, e.g. a molding process. Thus, the shaped body may be or may comprise at least one molded mass, such as a molded material, molded into a predefined form or shape. In particular, the shaped body may be a molded body and/or part, molded by using at least one forming and/or molding process, such as for example an extrusion process and/or a tableting process.

The term “retrieving” as used herein is a broad term and is to be given its ordinary and customary meaning to a person of ordinary skill in the art and is not to be limited to a special or customized meaning. The term specifically may refer, without limitation, to a process of a system specifically a computer system, of generating data and/or obtaining data from an arbitrary data source, such as from a data storage, from a network or from a further computer or computer system. The retrieving specifically may take place by at least one computer interface, such as via a port such as a serial or parallel port. The retrieving may comprise several sub-steps, such as the sub-step of obtaining one or more items of primary information and generating secondary information by making use of the primary information, such as by applying one or more algorithms to the primary information, e.g. by using a processor. Further, the retrieving may comprise obtaining data from one or more of at least one measurement, at least one calculation, literature, at least one handbook, knowledge, experience and at least one reference simulation. In particular, the retrieving in step a) may be or may comprise providing the set of target criteria to at least one processor of a computer, such as of the computer on which the computer-implemented method is performed. Thus, the retrieving in step a) may be or may comprise providing the set of target criteria to the processor, such by using at least one interface, e.g. of the computer.

The term “target criterion” as used herein is a broad term and is to be given its ordinary and customary meaning to a person of ordinary skill in the art and is not to be limited to a special or customized meaning. The term specifically may refer, without limitation, to a characteristic or specification which is targeted and/or aimed at when designing an arbitrary object or element. In particular, the target criterion may be or may comprise at least one reference characteristic and/or property with which a characteristic of the object and/or element is compared. As an example, the target criterion may be compared with at least one simulated criterion of the shaped body. Specifically, the target criterion may be a characteristic or specification for an application of the object or element, such as for an application of the shaped body. Thus, as an example, the target criterion may be or may comprise at least one characteristic, such as a reference characteristic, according to which the parameter, e.g. comprising the at least one geometry parameter of the seed geometry, is adapted. In particular, a plurality of target criteria may be referred to as being a set of target criteria.

The term “seed geometry” as used herein is a broad term and is to be given its ordinary and customary meaning to a person of ordinary skill in the art and is not to be limited to a special or customized meaning. The term specifically may refer, without limitation, to an arbitrary primary and/or initial two-dimensional and/or three-dimensional form or shape. In particular, the seed geometry may be or may comprise a three-dimensional basic type of the shaped body. Thus, the seed geometry may, for example, be an initial geometry for the shaped body, when designing the at least one shaped body. As an example, the seed geometry may be a predefined basic type of the shaped body. In particular, the seed geometry may be a two-dimensional and/or three-dimensional structure which may be described by using geometric forms, such as, for example, a cylinder, a pyramid, or the like. Additionally or alternatively, other computer and/or mathematical methods may be used for describing the seed geometry, such as one or more of at least one equation, at least one vector and at least one matrix. Additionally or alternatively, the seed geometry may be a combination of two-dimensional and/or three-dimensional structures and/or geometric forms, such as, for example, a pyramid with a cylindrical hole, or the like. Additionally or alternatively, the seed geometry may be a predefined and/or pre-existing geometry, such as a previously defined geometry, for example a geometry of a previous generation of shaped bodies. The seed geometry may, for example, be or may comprise a computer-generated geometry, such as a geometry automatically generated by a computer, e.g. by using at least one algorithm dedicated to generating geometries.

Thus, in other words, the seed geometry may refer to a starting geometry for the shaped body, when designing the shaped body, such as a starting point of the shaped body geometry. Specifically, the seed geometry may refer to a geometry being the starting geometry in the method for designing the at least one shaped body, such as to a starting geometry for the shaped body in the process of designing. Thus, the seed geometry may specifically refer to an initial geometry, such as the geometry at a beginning or starting point of the method. Specifically, the seed geometry may be the initial geometry of the shaped body at the beginning and/or start of the designing method, such as at an initial point of the simulation and/or optimization, e.g. of the simulating of step d) of the method. In particular, the seed geometry may refer to a start-point in the described computer-implemented method, which may subsequently be altered, for example in a simulation and/or optimization process, in order to reach one or more adequate results, such as at least one lead candidate geometry, e.g. as outlined in further detail below.

As used herein, the term “defining the seed geometry” may refer to one or more of generating, selecting and determining the seed geometry. The defining of the seed geometry may comprise generating the seed geometry depending on and/or in view of the at least one target criterion. The seed geometry may be a pre-defined seed geometry stored in data storage of the computer. The data storage may comprise at least one table or at least one lookup table comprising a plurality of different seed geometries. The defining of the seed geometry may comprise selecting one of the seed geometries such as depending on the at least one target criterion.

In particular, step b) of defining at least one seed geometry for the shaped body, may further comprise one or more sub-steps, such as a sub-step of providing the seed geometry to at least one processor of a computer, such as of the computer on which the computer-implemented method is performed. Thus, the defining in step b) may comprise providing the seed geometry to the processor, such by using at least one geometry defining unit, e.g. of the computer.

The term “parameter” as used herein is a broad term and is to be given its ordinary and customary meaning to a person skilled in the art and is not to be limited to a special or customized meaning. The term specifically may refer, without limitation, to an arbitrary variable representing at least one physical property of an object or system, wherein a value of the variable determines at least one characteristic or behavior of the object or system. In particular, the parameter may represent at least one property of the seed geometry, specifically of the seed geometry for the shaped body, such as a measured, calculated, estimated or tabulated property. Thus, the set of parameters may specifically be or may comprise at least one geometry parameter of the seed geometry, such as a parameter relating to a geometry and/or shape of the seed geometry. The parameter may be at least one variable selected from the group consisting of: a geometry parameter, e.g. a length, a thickness, a horizontal expansion and/or a vertical expansion, a side crush strength, a bulk crush strength; a material parameter, such as a Young's modulus, a hardness, an elasticity, a shear strength, a tensile strength, a heat capacity and/or a thermal conductivity; a chemical parameter, e.g. a reaction rate, a chemical conversion, a reaction yield and/or a reaction selectivity. In particular, the parameter may be one or more of a bulk density, a packed density, a weight, a surface area, a pore structure, an attrition rate, a flowability index, a diffusion coefficient, and the like, e.g. as described in “Handbook of Heterogeneous Catalysis” by Schüth et al. second, completely revised and enlarged edition, volume 1, p. 676 to 698. As used herein, the term “generating a set of parameters” refers to determining a plurality of parameters from the seed geometry.

In particular, step c) of generating a set of parameters comprising at least one geometry parameter of the seed geometry may further comprise one or more sub-steps, such as a sub-step of providing the set of parameters to at least one processor of a computer, such as of the computer on which the computer-implemented method is performed. Thus, the generating in step c) may further comprise providing the set of parameters to the processor, such by using at least one parameter generating unit, e.g. of the computer.

In particular, the set of parameters of the seed geometry, such as a set of variables determining at least one characteristic or behavior of the seed geometry for the shaped body, may, for example, be adapted or changed according to the target criteria, when simulating the shaped body in step d). As used herein, the term “simulating” is a broad term and is to be given its ordinary and customary meaning to a person skilled in the art and is not to be limited to a special or customized meaning. The term specifically may refer, without limitation, to a process of applying at least one simulation tool, such as an algorithm and/or a neural network, to an arbitrary object, such as an input value or initial value, for the purpose of determining at least one expected value and/or characteristic of the object.

Thus, in other words, the simulating may be or may refer to a process of optimizing. In particular, the process of simulating by applying the at least one simulating tool, such as repeatedly and/or iteratively applying one or more simulating tools, e.g. as outlined above or as described in further detail below, to an arbitrary object may synonymously be referred to as a process of optimizing, such as an optimization of at least one input value.

Specifically, as used herein, the term “simulating the shaped body” may refer to a process of applying at least one simulation tool to the set of generated parameters for the purpose of determining at least one adapted set of parameters of the shaped body. In particular, simulating the shaped body may comprise iteratively varying values of the set of parameters and determining for each value of at least one parameter at least one simulated criterion of the shaped body. Further, the at least one simulated criterion may be compared with at least one target criterion of the set of target criteria, in order to determine the values of the set of parameters for which the shaped body fulfills, at least within predetermined tolerances, the set of target criteria. As an example, the purpose of simulating the shaped body may specifically be or may comprise generating at least one adapted set of parameters, for example identifying at least one form or shape for the shaped body, for which the target criteria are fulfilled.

As used herein, the term “varying values of the set of parameters”, may refer to a process of changing a value of at least one parameter of the set of parameters, which may specifically be performed iteratively. In particular, the values of the set of parameters may be varied by following one or more of a preset and/or a predetermined pattern, a preset and/or a predetermined algorithm, a preset and/or a predetermined mathematical set of rules, a preset and/or a predetermined method or a preset and/or a predetermined protocol. Alternatively, the values of the set of parameters may be varied randomly.

In particular, simulating the shaped body, specifically in step d), as outlined above, may be or may comprise an iterative process, specifically an optimization process. Thus, as an example, when simulating the shaped body, specifically in step d), the set of parameters of the seed geometry, such as the values of a set of variables determining at least one characteristic or behavior of the seed geometry for the shaped body, may be changed and/or varied, e.g. randomly and/or by following one or more predetermined patterns. These changed parameters, e.g. the changed and/or varied values of parameters, when simulating the shaped body in step d), may then be analyzed, e.g. subsequently, in order to determine whether or not for these changed parameters the shaped body fulfills the set of target criteria, e.g. falls within predetermined tolerances of the target criteria. Again, as outlined above, this procedure may be performed iteratively, such as in case the target criteria are not met, e.g. as is commonly known in optimization procedures. As an example, if the shaped body having the geometry of the changed and/or varied parameters, e.g. of the changed and/or varied values of the set of parameters, does not fulfill the set of target criteria, the parameters, e.g. the values of the set of parameters, may again be changed and/or varied. Thus, as outlined above, e.g. in the previous paragraph, when simulating the shaped body in step d), the varying of the values of the set of parameters may specifically be performed iteratively, e.g. until a set of parameters, specifically values of the set of parameters, are such that the shaped body fulfills the set of target criteria, at least within predetermined tolerances.

As used herein, the term “simulated criteria”, may refer to at least one value and/or characteristic to be expected of a simulated object, in particular of the simulated shaped body having a certain set of parameters. Thus, the simulated criteria, specifically the simulated criteria of the shaped body, may for example be or may comprise at least one value and/or characteristic of the shaped body to be expected, in case the geometry of the shaped body equals a simulated geometry, such as the geometry as described by the values of the set of parameters used in the simulation, e.g. as described by the simulated values.

As used herein, the term “adapted set of parameters”, may refer to at least one set of values describing the shaped body, e.g. the geometry of the shaped body, for which the target criteria are fulfilled at least within predetermined tolerances. Thus, the adapted set of parameters may specifically be or may comprise at least one outcome of simulating the shaped body. In particular, in step d), the set of parameters may be adapted by comparing simulated criteria, such as simulated characteristics or specifications, for varying values of the set of parameters with the set of target criteria. Thus, an adapted set of parameters may be generated, for which the target criteria are fulfilled at least within predetermined tolerances.

In other words, the adapted set of parameters may specifically refer to an adapted set of values of parameters. Thus, the adapted set of parameters, e.g. the set of adapted values of parameters, may specifically refer to a set of adapted parameter values for which the target criteria are fulfilled, e.g. at least within predetermined tolerances.

The term “fulfilled” as used herein is a broad term and is to be given its ordinary and customary meaning to a person skilled in the art and is not to be limited to a special or customized meaning. The term specifically may refer, without limitation, to an achievement of an arbitrary goal, such as complying with at least one predefined or preset criterion. Thus, the term “fulfilled at least within predetermined tolerances” specifically may refer, without limitation, to an arbitrary status of reaching a predefined goal by complying with the at least one predefined or preset criterion, wherein a predetermined tolerance may be applied when determining the achievement.

The term “the target criteria are fulfilled at least within predetermined tolerances” refers to the fact that the target criteria are completely fulfilled wherein deviations are possible within the predetermined tolerances. In detail, the adapted set of parameter as generated in step d) may define a geometry of the shaped body for which the target criteria may be fulfilled or achieved, wherein an optimum may be missed so long as a discrepancy or deviation is smaller than the predetermined tolerances. As an example, the target criteria may be considered being fulfilled so long as an optimum or maximum fulfillment of the target criteria may be reached. Specifically, the target criteria may be fulfilled so long as a maximum or minimum, for example a global maximum or a global minimum, of at least one target criteria is reached. Thus, the target criteria may be considered to be fulfilled or achieved so long as a minimum discrepancy and/or a minimum deviation is reached. Additionally or alternatively, the target criteria may be fulfilled at least within predetermined tolerances as long as a difference or discrepancy between the simulated criteria and the target criteria is smaller to or equals the predetermined tolerances. Specifically, the target criteria may be considered to be fulfilled so long as the simulated criteria and the target criteria differ from each other by no more than 50%, preferably by no more than 20%, more preferably by no more than 10%.

The term “geometry” as used herein is a broad term and is to be given its ordinary and customary meaning to a person skilled in the art and is not to be limited to a special or customized meaning. The term specifically may refer, without limitation, to a two-dimensional and/or three-dimensional form or shape of an arbitrary object. The geometry may specifically be described and/or defined mathematically, e.g. by a mathematical function. Additionally or alternatively, the geometry may be described by using at least one data format generally used by computers, e.g. computer methods for describing geometries, such as one or more of: a point cloud, at least one vector, at least one matrix, a constructive solid geometry (CSG) representation and a hybrid method.

The term “lead candidate geometry” as used herein is a broad term and is to be given its ordinary and customary meaning to a person skilled in the art and is not to be limited to a special or customized meaning. The term specifically may refer, without limitation, to a form or shape of the at least one shaped body for which the target criteria are fulfilled at least within predetermined tolerances. Thus, it may specifically be possible to determine multiple lead candidate geometries for all of which the target criteria are fulfilled at least within predetermined tolerances. In particular, the at least one lead candidate geometry may be determined from the adapted set of parameters as generated in step d). As an example, the lead candidate geometry may be determined from the adapted set of parameters by transforming the values of the adapted set of parameters into a mathematical description, such as into a mathematical function, describing the geometry of the shaped body for which the target criteria are fulfilled. In particular, the lead candidate geometry may be or may comprise a negative geometry of a starting geometry used when designing at least one die, e.g. for manufacturing the shaped body.

In particular, the lead candidate geometry may specifically be or may refer to a geometry being the result of the designing method, such as the outcome of the simulation and/or optimization. Specifically, the lead candidate geometry may be the result of the simulating of step d) of the method. Thus, the lead candidate geometry may be the resulting geometry for the shaped body, when performing the designing method, such as the outcome of the designing method. In particular, the lead candidate geometry may refer to an output of the described computer-implemented method. Specifically, the lead candidate geometry may be a two-dimensional and/or tree-dimensional structure, whose basic shape may be similar to the seed geometry. In particular, with respect to the seed geometry, the basic shape of the lead candidate geometry may remain unamended, such that e.g. a cylinder remains a cylinder, a pyramid remains a pyramid, a cube remains a cube, and the like. Thus, as an example, in case the target criteria are already fulfilled for the seed geometry, the lead candidate geometry may only slightly differ from the seed geometry or even equal the seed geometry.

The set of target criteria in step a) may be retrieved via at least one interface, specifically, via at least one web interface. The term “interface” as used herein is a broad term and is to be given its ordinary and customary meaning to the person skilled in the art and is not to be limited to a special or customized meaning. The term specifically may refer, without limitation, to an item or element forming a boundary configured for transferring information. In particular, the interface may be configured for transferring information from a computational device, e.g. a computer, such as to send or output information, e.g. onto another device. Additionally or alternatively, the interface may be configured for transferring information onto a computational device, e.g. onto a computer, such as to receive information. The interface, e.g. the web interface, may specifically provide means for transferring or exchanging information, in particular, online, such as via internal or external, for example by an Internet connection. In particular, the interface may provide a data transfer connection, e.g. Bluetooth, NFC, inductive coupling or the like. As an example, the interface or port may be or may comprise one or more of a network or Internet port, a USB-port and a drive disk. In particular, the web interface may be or may comprise one or more of a software interface, a script, a database interface.

Further, the at least one lead candidate geometry of the shaped body may be output via the at least one interface. The term “output” as used herein is a broad term and is to be given its ordinary and meaning to a person of ordinary skill in the art and is not to be limited to a special or customized meaning. The term specifically may refer, without limitation, to the process of making information available to another system, data storage, person or entity. As an example, the output may take place via one or more interfaces, such as a computer interface, a web interface or a human-machine interface. The output, as an example, may take place in one or more of a computer-readable format, a visible format or an audible format.

The target criteria may specifically contain at least one constraint selected from the group consisting of: a geometry constraint, such as a production machine tolerance, a wall minimum thickness, a tabletability constraint, an extrudability constraint, a maximum and/or minimum diameter constraint, a maximum and/or minimum height constraint, specifically a geometric constraint referring to dimensions of existing shaping machines or existing application reactors, e.g. an adequate die filling height, a tableting pressing force, an adequate rotation speed, an adequate throughput, a long term stability of tableting parameters, an adequate ejection force, a maximum torque, an extrusion pressure, an extrusion throughput; a weight constraint, specifically a weight constraint referring to a maximum weight inside an application reactor in which the shaped body may be applied; a surface area constraint, such as a maximum surface area per weight, a maximum Brunauer-Emmett-Teller (BET) surface area; a density constraint; a mechanical strength constraint, a compressive crushing strength, a tensile strength, a shear strength, a bending strength, a torsion strength, a cutting strength, an attrition, an abrasion, an elasticity, a torsion strength; a pressure drop constraint; a heat transport constraint; a mass transport constraint; a productivity constraint; a shaping process constraint; an economic constraint, e.g. a production cost, a sales price, a profit margin, a line productivity. In particular the target criteria may for example contain at least one constraint coming from a shaping process or existing due to a shaping limitation of the shaping process.

In particular, the set of target criteria may comprise at least one mechanical strength constraint and/or at least one pressure drop constraint or may even consist of the at least one mechanical strength constraint and/or the at least one pressure drop constraint.

In particular, at least one of the target criteria of the set of target criteria may comprise at least one condition to be fulfilled by the shaped body. Thus, the shaped body, for example, may need to fulfill the at least one condition of the at least one target criterion in order for the target criteria to be considered fulfilled.

Further, as an example, the condition may be a condition to be fulfilled by a measurable property of the shaped body. Thus, the shaped body may specifically comprise at least one measurable property, wherein, in order for the shaped body to be considered to fulfill the target criteria, the at least one measurable property of the shaped body may, for example, need to fulfill the at least one condition of the at least one target criterion. The term “measurable property” as used herein is a broad term and is to be given its ordinary and customary meaning to a person of ordinary skill in the art and is not to be limited to a special or customized meaning. The term specifically may refer, without limitation, to an arbitrary qualitatively or quantitatively determinable characteristic or specification of an object or element. Thus, the measurable property of the shaped body may particularly refer to a qualitatively or quantitatively determinable characteristic of the shaped body.

In particular, the measurable property may be selected from the group consisting of: a geometry parameter of the shaped body; a weight of the shaped body; a surface area of the shaped body; a density of the shaped body; a pore structure of the shaped body; a mechanical strength of the shaped body; a pressure drop parameter; a heat transport parameter; a mass transport parameter; a productivity parameter; a elasticity property of a material of the shaped body, specifically a Young module of a material of the shaped body; a shape property, such as a side crush strength, a bulk crush strength, a tensile strength; a chemical conversion parameter, such as a reaction rate, a chemical conversion, a reaction yield, a reaction selectivity, a conveying parameter, such as a flow index.

Specifically, a test and/or a verification, if the condition is fulfilled, may specifically comprise a comparison of the measurable property with at least one numerical value. In particular, the test and/or verification of fulfillment of the condition may, for example, comprise a comparison of the measurable property with at least one of: a single numerical value, specifically a threshold value; a plurality of numerical values, specifically a range; a target value.

The condition may, for example, be a condition to be fulfilled by a qualitative property of the shaped body. Specifically, as an example, the condition may be a condition to be fulfilled by a qualitative property of the shaped body or of a variety of shaped bodies, such as of a variety of shaped bodies in a defined or undefined assembly.

The target criteria may comprise at least one suitability of the shaped body for at least one predetermined application purpose. Specifically, as an example, the target criteria may comprise at least one suitability of the shaped body selected from the group consisting of: a suitability for application in a predetermined reactor, a suitability for application under predetermined pressure, a suitability for application at a predetermined temperature, a suitability for application with at least one predetermined reactant, a suitability for application in a predetermined reaction, a suitability for application under at least one predetermined flow condition, a suitability for application in at least one predetermined mass flow, a suitability for application in at least one predetermined heat flow, a suitability for application under at least one predetermined mechanical stress.

The retrieving may comprise a preprocessing, specifically a preprocessing of at least one target criterion of the set of target criteria. As an example, step a), particularly the preprocessing, may further comprise weighing the target criteria. In particular, when retrieving the at least one set of target criteria for the shaped body in step a), the target criteria may further be weighed, such as ranked or given equal or different priorities. For example, in case individual target criteria from the set of target criteria may be considered more or less important than other target criteria, these individual target criteria may be given a higher or lower priority. Thus, the target criteria from the set of target criteria may be weighed individually. However, alternatively, each target criteria from the set of target criteria may be considered to be equally important. Thus, each target criteria from the set of target criteria may be weighed equally.

Step a) may further comprise retrieving at least one information on a material to be used for the shaped body. Thus, when retrieving the at least one set of target criteria from the shaped body in step a), additionally, at least one material to be used for the shaped body may be retrieved. Specifically, at least one material property of the at least one material to be shaped by the shaping tool may be retrieved. For example, the material property may be or may comprise one or more of a rheology parameter, e.g. a rheology of a catalyst paste, such as for extrusion, a compressibility compactability curve, such as for tableting, a density, such as a density of a powder to be tableted, e.g. a pill mix, or the like.

The adapted set of parameters in step d) may, for example, be generated by applying at least one operation, e.g. a mathematical and/or logical method, selected from the group consisting of: a non-linear algorithm; a stochastic algorithm; a genetic algorithm; an artificial intelligence algorithm; a gradient-based algorithm; a multi-criteria optimization function, specifically at least one of a weighted sum function or an ε-constraint function; sequential quadratic programming; method of feasible directions; quasi-newton method; newton method.

In particular, the adapted set of parameters may, as an example, be generated by performing an optimization method, such as for example a multi-criteria approach optimization method. Specifically, constraints and/or boundary conditions may be used in the optimization method, such as in the multi-criteria approach. In particular, the at least one constraint may be or may comprise at least one mathematical function, such as a mathematical function constraining the optimization. Thus, as an example, a height being lower than a diameter may be considered a constraint. Further, the at least one boundary condition may specifically be understood as an allowable range, e.g. a range for the parameter space to be searched. Thus, the range between a minimum height and a maximum height may be considered a boundary condition. In particular, the at least one boundary condition may be or may comprise at least one boundary condition from the target criteria, e.g. from the target values and/or limitations due to a production process, such as a production process of the shaped body, or the like. Specifically, in the optimization method, e.g. in the multi-criteria approach optimization method, at least one minimum value and at least one maximum value for a response function may be pre-set, e.g. set as a boundary condition, as an example, for a pressure drop and/or a mechanical strength. As an example, in the multi-criteria approach, the set of parameters, specifically the set of parameters comprising the at least one geometry parameter, may be changed or varied once, repeatedly or in an iterative pattern, such as to determine the at least one adapted set of parameters.

As an example, step d) may further comprise simulating the shaped body by varying values of the adapted set of parameters.

The shaped body may specifically be an element selected from the group consisting of: a packed bed material, such as a packed bed material used in a scrubbing tower or scrubber; a tower packing, such as a wash tower packing; a catalyst, more specifically a catalyst pellet, a catalyst extrudate, a catalyst granulate; an adsorbent, more particularly an adsorbent pellet, an adsorbent extrudate, an adsorbent granulate; a filter. In particular, as an example, the shaped body may be or may comprise at least one or more than one elements of a packed bed, for example used in a scrubbing tower or scrubber, wherein specifically the shaped body may be configured for providing a maximum surface area for fluids, such as a maximum contact area between a gas to be cleaned and a scrubbing liquid. Further, the shaped body may, as an example, be used in a distillation procedure. Specifically, the shaped body may, for example, be applied in moving and/or fluidized and/or entrained bed reactors, such as in any possible packing of a solid phase, such as a solid phase coming into contact with a fluid phase, e.g. with one or more of a liquid phase, a gaseous phase and a supercritical phase.

In a further aspect of the invention, a computer-implemented method for designing at least one shaping tool is disclosed. The method may also be referred to as method, shaping tool designing method, die design method or die designing method. The method comprises the following steps, which may be performed in the given order. However, a different order may also be possible. Further, one or more than one or even all of the steps may be performed once or repeatedly. Further, the method steps may be performed in a timely overlapping fashion or even in parallel. The method may further comprise additional method steps which are not listed.

The computer-implemented method for designing at least one shaping tool comprises the following steps:
i) retrieving at least one set of shaping target criteria for the die;
ii) defining at least one starting geometry for the die;
iii) generating a set of shaping parameters comprising at least one shape geometry parameter of the starting geometry;
iv) simulating a shaping process using the shaping tool by varying values of the set of shaping parameters and by comparing simulated shaping properties for these values with the set of shaping target criteria, thereby generating at least one shaping geometry with an adapted set of shaping parameters for which the shaping target criteria are fulfilled at least within predetermined tolerances; and
v) determining at least one geometry of the at least one shaping tool from the adapted set of shaping parameters.

The method for designing at least one shaping tool may be used for designing at least one shaping tool, e.g. at least one die, to be used in a granulation process and/or a tableting process, such as in a spray drying process, and/or in an extrusion process. In particular, the method for designing at least one shaping tool may be used for designing at least one shaping tool, e.g. die, to be used in an arbitrary shaping or manufacturing process, wherein various shaping methods, such as granulation and agglomeration, may be used. In particular, the shaping tool and/or die may, for example, be used in a molding process and/or in an additive manufacturing process. Thus, in particular, the shaping tool and/or die may also be referred to as mold, specifically as a mold configured for being used in a molding process.

As an example, the shaping tool, e.g. the die, may be manufactured for example in a molding process and/or in a machining process and/or in an additive manufacturing process.

Specifically, the shaping tool may be or may comprise at least a part of one or more of a tableting tool and an extrusion die. In particular, the shaping tool may be or may comprise the extrusion die, such as a die used in an extrusion process. Specifically, the shaping tool may be or may comprise the tableting tool, such as a tool, e.g. at least one die, used in a tableting process.

In particular, the term “tableting process” as used herein is a broad term and is to be given its ordinary and customary meaning to a person of ordinary skill in the art and is not limited to a special or customized meaning. The term specifically may refer, without limitation, to a manufacturing process in which an object or part is produced by using a tableting tool applying pressure onto at least one material thereby generating the object or part. In particular, the tableting process may be configured for transferring a negative form and/or geometry of the tableting tool onto the pressured material. Thus, the tableting process may be or may comprise a compacting process, in which the object or part is formed from the material by applying pressure onto the material, e.g. by compacting the material. In particular, the tableting process may be or may comprise a molding process, using a mold, such as a die, as a form giving entity.

The term “additive manufacturing” as used herein is a broad term and is to be given its ordinary and customary meaning to a person of ordinary skill in the art and is not to be limited to a special or customized meaning. The term specifically may refer, without limitation, to a manufacturing process in which an object or part is produced by a step-by-step addition of at least one material. In particular, additive manufacturing may comprise a layer built up, such as by adding material in a first horizontal plane and then subsequently adding material in a second horizontal plane and so on, thereby building up the object and/or part. Specifically, additive manufacturing may be or may comprise one or more of: Selective Laser Melting (SLM), Stereolithographie (SLA), Fused Deposition Modeling (FDM) and Direct Energy Deposition (DED). In detail, additive manufacturing may comprise building up a part layer wise. Additive manufacturing may allow using a brought variety of materials like different plastics, metals or ceramics, separately or in combination.

The term “designing at least one shaping tool” as used herein is a broad term and is to be given its ordinary and customary meaning to a person of ordinary skill in the art and is not to be limited to a special or customized meaning. The term specifically may refer, without limitation, to a procedure of planning and/or specifying at least one shaping tool, e.g. at least one die. In particular, the designing of at least one shaping tool may specifically be or may comprise developing and/or defining at least one property of the shaping tool, such as, for example, a geometry and/or shape of the shaping tool.

The term “shaping tool” as used herein is a broad term and is to be given its ordinary and customary meaning to a person of ordinary skill in the art and is not to be limited to a special or customized meaning. The term specifically may refer, without limitation, to an arbitrary form giving tool. The shaping tool may for example comprise a form or mold, such as a form giving matrix or frame. Specifically, the shaping tool may be used in a shaping process used for manufacturing the shaped body. The shaping tool may specifically be a form giving tool used in an arbitrary shaping or manufacturing process suitable for manufacturing the shaped body.

As an example, the shaping tool may be or may comprise one or more of a tableting tool, specifically a tableting tool comprising a die, and an extrusion die. The shaping tool may specifically be or may comprise the die. Thus, herein the term “die” specifically may refer to at least a part of the shaping tool. Additionally or alternatively, herein the terms “shaping tool” and “die” may be used interchangeably.

The term “shaping target criterion” as used herein is a broad term and is to be given its ordinary and customary meaning to a person of ordinary skill in the art and is not to be limited to a special or customized meaning. The term specifically may refer, without limitation, to a characteristic or specification which is targeted at when designing an arbitrary shaping object or element. In particular, the shaping target criterion may be or may comprise at least one reference characteristic or property with which a characteristic of the shaping object or element, e.g. a simulated criterion, is compared. Specifically, the shaping target criterion may be a characteristic or specification for an application of the shaping object or element, such as for an application of the shaping tool or die, e.g. for using the shaping tool for shaping or manufacturing the shaped body. Thus, as an example, the shaping target criterion may be or may comprise at least one characteristic, such as a reference characteristic, according to which the shaping parameter, e.g. comprising the at least one shape geometry parameter of the starting geometry, is adapted. In particular, a plurality of shaping target criteria may be referred to as being a set of shaping target criteria.

In particular, the retrieving of the at least one set of shaping target criteria for the die in step i) may be or may comprise providing the set of shaping target criteria to at least one processor of a computer, such as of the computer on which the computer-implemented method is performed. Thus, the retrieving in step i) may be or may comprise providing the set of shaping target criteria to the processor, such by using at least one interface, e.g. an interface of the computer.

The term “starting geometry” as used herein is a broad term and is to be given its ordinary and customary meaning to a person of ordinary skill in the art and is not to be limited to a special or customized meaning. The term specifically may refer, without limitation, to an arbitrary primary and/or initial two-dimensional and/or three-dimensional form or shape. In particular, the starting geometry may be or may comprise a two-dimensional and/or three-dimensional basic type of a shaping tool and/or die. In particular, the starting geometry for the shaping tool may, for example, be an initial geometry of the shaping tool and/or die, when designing the at least one shaping tool. As an example, the starting geometry for the shaping tool may be a predefined basic type of the shaping tool and/or die, such as a previously determined geometry, and/or a geometry of a previous generation of shaping tools and/or dies. Specifically, the starting geometry for the shaping tool and/or die may be or may comprise a raw form or shape of the shaping tool and/or die. Starting geometry may, for example, be or may comprise a computer-generated geometry, such as a geometry automatically generated by a computer, e.g. by using at least one algorithm dedicated to generating geometries. Additionally or alternatively, the starting geometry may be generated from previously defined starting geometries, such as from experience.

As used herein, the term “defining the starting geometry” may refer to one or more of generating, selecting and determining the starting geometry. The defining of the starting geometry may comprise generating the starting geometry depending on and/or in view of the at least one shaping target criteria. The starting geometry may be a pre-defined starting geometry stored in a data storage of the computer. The data storage may comprise at least one table or at least one lookup table comprising a plurality of different starting geometries. The defining of the starting geometry may comprise selecting one of the starting geometries for example depending on the at least one shaping target criterion.

In particular, step ii) of defining at least one starting geometry for the die, may further comprise one or more sub-steps, such as a sub-step of providing the starting geometry to at least one processor of a computer, such as of the computer on which the computer-implemented method is performed. Thus, the defining in step ii) may comprise providing the starting geometry to the processor, such by using at least one geometry defining unit, e.g. a geometry defining unit of the computer.

The term “shaping parameter” as used herein is a broad term and is to be given its ordinary and customary meaning to a person skilled in the art and is not to be limited to a special or customized meaning. The term specifically may refer, without limitation, to an arbitrary variable representing at least one physical property of a shaping object or system, wherein a value of the variable determines at least one characteristic and/or behavior of the shaping object or system. In particular, the parameter may represent at least one property of the starting geometry, specifically the starting geometry for the shaping tool. Thus, a set of shaping parameters may specifically be or may comprise at least one geometry parameter of the starting geometry, such as a parameter relating to a geometry or shape of the starting geometry for the shaping tool. In particular, the set of shaping parameters of the starting geometry, such as a set of variables determining at least one characteristic and/or behavior of the starting geometry for the shaping tool, may for example be adapted or changed according to the shaping target criteria, when simulating a shaping process using the shaping tool in step iv). In particular, shaping parameter may represent at least one property and/or behavior of the shaping tool when the shaping tool is used for shaping at least one object. Thus, the set of shaping parameters may specifically be or may comprise at least one shape geometry parameter of the starting geometry. The shaping parameter may be at least one variable selected from the group consisting of: a geometric parameter, e.g. a length, a thickness, a horizontal expansion and/or a vertical expansion, specifically of a cut out and/or a hole and/or a negative geometry, e.g. of a mold or matrix, of the shaping tool; a material parameter of the shaping tool, such as a Young's modulus, a hardness, an elasticity, a shear strength, a tensile strength, a heat capacity and/or a thermal conductivity; a material parameter of the object to be shaped by using the shaping tool, such as a hardness, an elasticity, a shear strength, a tensile strength, a viscosity, a heat capacity and/or a thermal conductivity; a process parameter, such as a pressure, specifically a tableting pressure, and/or a velocity, such as an extrusion velocity. Further, as an example, the shaping parameter may be or may comprise a surface quality, e.g. a roughness and/or smoothness; a shaping machine parameter, such as a boundary condition of a shaping machine, for example a maximum diameter of an extrusion die, e.g. the maximum diameter being limited by a size of an extrusion machine. As used herein, the term “generating a set of shaping parameters” refers to determining a plurality of shaping parameters from the starting geometry.

In particular, step iii) of generating a set of shaping parameters comprising at least one shape geometry parameter of the starting geometry may further comprise one or more sub-steps, such as a sub-step of providing the set of shaping parameters to at least one processor of a computer, such as of the computer on which the computer-implemented method is performed. Thus, the generating in step iii) may further comprise providing the set of shaping parameters to the processor, such as by using at least one shaping parameter generating unit, e.g. a shaping parameter generating unit of the computer.

Specifically, as used herein, the term “simulating a shaping process using the shaping tool” may refer to a process of applying at least one simulation tool to the shaping tool and/or die for the purpose of determining at least one adapted set of shaping parameters. In particular, simulating a shaping process using the shaping tool may comprise iteratively varying values of the set of shaping parameters and determining for each value of at least one shaping parameter at least one simulated shaping property of the shaping tool. Further, the at least one simulated shaping property may be compared with at least one shaping target criterion of the set of shaping target criteria, in order to determine the values of the set of shaping parameters for which the shaping tool fulfills, at least within predetermined tolerances, the set of shaping target criteria. As an example, the purpose of simulating the shaping process using the shaping tool may specifically be or may comprise generating at least one adapted set of shaping parameters, for example identifying at least one form or shape for the shaping tool, for which the shaping target criteria are fulfilled.

In particular, as outlined above, the simulating may be or may refer to a process of optimizing. Thus, the term simulating a shaping process using a shaping tool may specifically be or may comprise a process of optimizing a shaping process.

As used herein, the term “varying values of the set of shaping parameters”, may refer to a process of changing a value of at least one shaping parameter of the set of shaping parameters, which may specifically be performed iteratively. In particular, the values of the set of shaping parameters may be varied by following a preset and/or a predetermined pattern or protocol. Alternatively, the values of the set of shaping parameters may be varied randomly.

In particular, simulating the shaping process, specifically in step iv), as outlined above, may be or may comprise an iterative process, specifically an optimization process. Thus, as an example, when simulating the shaping process using the shaping tool, specifically in step iv), the set of shaping parameters of the starting geometry, such as the values of a set of variables determining at least one characteristic or behavior of the starting geometry for the shaping tool, may be changed and/or varied, e.g. randomly and/or by following one or more predetermined patterns. These changed parameters, e.g. the changed and/or varied values of shaping parameters, when simulating the shaping process in step iv), may then be analyzed, e.g. subsequently, in order to determine whether or not for these changed shaping parameters the shaping tool fulfills the set of target criteria, e.g. falls within predetermined tolerances of the target criteria. Again, as outlined above, this procedure may be performed iteratively, such as in case the shaping target criteria are not met, e.g. as is commonly known in optimization procedures. As an example, if the shaping tool having the geometry of the changed and/or varied shaping parameters, e.g. of the changed and/or varied values of the set of shaping parameters, does not fulfill the set of shaping target criteria, the shaping parameters, e.g. the values of the set of shaping parameters, may again be changed and/or varied. Thus, as outlined above, e.g. in the previous paragraph, when simulating the shaping process using the shaping tool in step iv), the varying of the values of the set of shaping parameters may specifically be performed iteratively, e.g. until a set of shaping parameters, specifically values of the set of shaping parameters, are such that the shaping process using the shaping tool fulfills the set of shaping target criteria, at least within predetermined tolerances.

As used herein, the term “simulated shaping properties”, may refer to at least one value and characteristic to be expected of a simulated object and/or process. Thus, the simulated shaping properties, specifically the simulated shaping properties of the shaping tool, may for example be or may comprise at least one value and/or characteristic of the shaping tool to be expected when using the shaping tool in the shaping process. In particular, the simulated shaping properties of the shaping tool may comprise at least one expected value of the shaping tool when using the shaping tool in the shaping process, in case the geometry of the shaping tool used in the shaping process equals a simulated geometry shaping tool and a simulated shaping process. Specifically, the simulated shaping properties, for example, may be or may comprise at least one expected value of the shaping tool in case the geometry as described by the values of the set of shaping parameters used in the simulation equals the simulated geometry.

As used herein, the term “adapted set of shaping parameters”, may refer to at least one set of values describing the shaping tool, e.g. the geometry of the shaping tool, for which the shaping target criteria are fulfilled at least within predetermined tolerances. Thus, the adapted set of shaping parameters may specifically be or may comprise at least one outcome of simulating the shaping process using the shaping tool. In particular, in step iv), the set of shaping parameters may be adapted by comparing simulated shaping properties, such as simulated characteristics or specifications, for varying values of the set of shaping parameters with the set of shaping target criteria. Thus, an adapted set of shaping parameters may be generated, for which the shaping target criteria are fulfilled at least within predetermined tolerances.

In other words, the adapted set of shaping parameters may specifically refer to an adapted set of values of shaping parameters. Thus, the adapted set of shaping parameters, e.g. the set of adapted values of shaping parameters, may specifically refer to a set of adapted shaping parameter values for which the shaping target criteria are fulfilled, e.g. at least within predetermined tolerances.

In particular, in step iv), the set of shaping parameters may be adapted by comparing simulated criteria, such as simulated characteristics or specifications, for varying values of the set of shaping parameters with the set of shaping target criteria. Thus, an adapted set of shaping parameters may be generated, for which the shaping target criteria are fulfilled at least within predetermined tolerances. The term “the shaping target criteria are fulfilled at least within predetermined tolerances” refers to the fact that the shaping target criteria are completely fulfilled wherein deviations are possible within the predetermined tolerances. In detail, the adapted set of shaping parameter as generated in step iv) may define a geometry of the shaping tool for which the shaping target criteria may be fulfilled or achieved, wherein an optimum may be missed so long as a discrepancy or deviation is smaller than the predetermined tolerances. As an example, the shaping target criteria may be considered being fulfilled so long as an optimum or maximum fulfillment of the shaping target criteria may be reached. Specifically, the target criteria may be fulfilled so long as a maximum or minimum, for example a global maximum or a global minimum, of at least one shaping target criteria is reached. Thus, the shaping target criteria may be considered to be fulfilled or achieved so long as a minimum discrepancy and/or a minimum deviation is reached. Additionally or alternatively, the shaping target criteria may be fulfilled at least within predetermined tolerances as long as a difference or discrepancy between the simulated criteria and the shaping target criteria is smaller to or equals the predetermined tolerances. Specifically, the shaping target criteria may be considered to be fulfilled so long as the simulated criteria and the shaping target criteria differ from each other by no more than 50%, preferably by no more than 20%, more preferably by no more than 10%.

The starting geometry may specifically be a negative geometry of the at least one lead candidate geometry, designed by using the computer-implemented method for designing at least one shaped body, as described above or as will be described in further detail below. Thus, for possible definitions of terms used herein, reference may be made to the description of the computer-implemented method for designing at least one shaped body as disclosed in the first aspect of the present invention.

The shaping target criteria may specifically comprise at least one suitability of the shaping tool for shaping at least one predetermined object. Thus, at least one shaping target criteria of the set of shaping target criteria may be or may comprise the at least one suitability of the shaping tool for shaping at least one predetermined object. The predetermined object may, for example, be or may comprise the shaped body designed by using the computer-implemented method for designing at least one shaped body, as described above or as will be described in further detail below. Thus, as an example, at least one shaping target criteria may be or may comprise the suitability of the shaping tool for shaping the shaped body.

The set of shaping target criteria in step i) may, for example, be retrieved via at least one interface, specifically via at least one web interface. Additionally or alternatively, the at least one geometry of the shaping tool may be output via the at least one interface.

The shaping target criteria may specifically contain at least one constraint selected from the group consisting of: a surface property constraint; a geometry constraint, specifically a geometry constraint of an object to be shaped by using the shaping tool; a pressure constraint; a shear force constraint; a compaction force constraint; an ejection force constraint; a die-filling constraint; a productivity constraint; an economic constraint, e.g. a price and/or a profit margin; a force distribution constraint; a velocity distribution constraint; a mechanical stability constraint; a strength constraint, such as a tensile strength constraint; a pore size constraint; a weight constraint; an attrition performance constraint; a production machine constraint, e.g. a dimension of the production machine; a production constraint, e.g. a limitation for the design due to the production technology.

Further, at least one of the shaping target criteria of the set of shaping target criteria may, for example, comprise at least one condition to be fulfilled by the shaping tool. Thus, the shaping tool, for example, may needs to fulfill the at least one condition of the at least one shaping target criterion in order for the shaping target criteria to be considered fulfilled.

As an example, the condition may be a condition to be fulfilled by a measurable property of the shaping tool. Thus, the shaping tool may specifically comprise at least one measurable property, wherein in order for the shaping tool to be considered to fulfill the shaping target criteria, the at least one measurable property of the shaping tool may, for example, need to fulfill the at least one condition of the at least one shaping target criterion. In particular, the at least one measurable property of the shaping tool may particularly refer to a qualitatively or quantitatively determinable characteristic of the shaping tool. Specifically, the condition may be a condition to be fulfilled by a performance of the shaping tool, specifically one or more of: if the shaping tool is suited for manufacturing the shaped body, e.g. suited for providing and/or withstanding a pre-defined sheer stress and/or pressure drop across the shaping tool, e.g. across the die, and/or an ejection force, specifically an ejection force of a tableting tool; lifetime in process; productivity, e.g. a minimum productivity measured for example in kilogram per hour [kg/h], a yield, such as a maximum yield, e.g. a minimal quantity of production rejects.

The measurable property of the shaping tool may specifically be selected from the group consisting of: a surface parameter of the shaping tool; a geometry parameter of the shaping tool; a geometry parameter of an object to be shaped by using the shaping tool; a pressure parameter; a shear force; a compaction force; an ejection force; a productivity parameter; a property of a material of an object to be shaped by using the shaping tool, specifically a viscosity, a powder bulk density, a compressibility, a compactability, such as in the ability to be compacted, e.g. a compressibility-compactability curve, a cohesion; a flowability, such as an ability two flow; a particle size distribution; a crush strength of primary particles; a pore structure.

Specifically, a test and/or a verification, if the condition is fulfilled, may for example comprise a comparison of the measurable property with at least one numerical value. Specifically, the test and/or verification of fulfillment of the condition may comprise a comparison of the measurable property with at least one of: a single numerical value, specifically a threshold value; a plurality of numerical values, specifically a range; a target value.

As an example, step i) may further comprise weighing the target criteria. In particular, when retrieving the at least one set of shaping target criteria for the shaping tool in step i), the shaping target criteria may further be weighed, such as ranked or given equal or different priorities.

Step i) may further comprise retrieving, for example, at least one material to be shaped by the shaping tool. Thus, in particular, additionally to retrieving the at least one set of shaping target criteria for the shaping tool, step i) may further comprise retrieving the at least one material to be shaped by the shaping tool, such as for example the material of the shaped body.

Step iv) may further comprise simulating the shaping process using the adapted set of shaping parameters.

The adapted set of shaping parameters in step iv) may be generated by applying at least one operation selected from the group consisting of: a non-linear algorithm; a stochastic algorithm; a genetic algorithm; an artificial intelligence algorithm; a gradient-based algorithm; a multi-criteria optimization function, specifically at least one of a weighted sum function or an ε-constraint function; sequential quadratic programming; method of feasible directions; quasi-newton method; newton method.

The computer-implemented method for designing at least one shaping tool may, for example, further comprise:
vi) prototyping the at least one shaping tool from the at least one geometry of the shaping tool determined in step v).

The term “prototyping” as used herein is a broad term and is to be given its ordinary and customary meaning to a person of ordinary skill in the art and is not to be limited to a special or customized meaning. The term specifically may refer, without limitation, to the process of manufacturing a full-scale and functional model or form of an arbitrary element or object. In particular, the prototype may be a first model of an element or object and may be used for testing and/or verification of at least one characteristic or specification of the element or object. Specifically, the prototype may be manufactured prior to a large-scale production process or a mass production process. A prototype may, for example, be produced or manufactured as a part of a development phase of the element or object, such as of the at least one shaping tool. Thus, the prototyping of the at least one shaping tool may specifically be performed before starting a large-scale production process or manufacturing of the shaping tool.

In step vi) at least one process may be used, wherein the process may be a prototyping process and may be selected from the group consisting of: a rapid prototyping process, specifically an additive manufacturing process, more specifically one or more of a 3D printing process or an additive layer manufacturing process; a conventional prototyping process, e.g. a subtractive prototyping process; a spark erosion process. However, additionally or alternatively, any other prototyping process may be used for prototyping the at least one shaping tool in step vi).

The computer-implemented method for designing at least one shaping tool may, for example, further comprise:

vii) validating the prototyped shaping tool by comparing at least one property of the prototyped shaping tool with at least one property of a simulated shaping tool.

The computer-implemented method for designing at least one shaping tool may specifically be or may comprise an independently performed method. Alternatively however, the computer-implemented method for designing at least one shaping tool may be part of the computer-implemented method for designing at least one shaped body, e.g. as outlined above. Thus, in particular, the computer-implemented method for designing at least one shaped body may further comprise the computer-implemented designing of at least one shaping tool for manufacturing the shaped body, specifically the computer-implemented method for designing at least one shaping tool comprising at least steps i) to v) as outlined above and/or as described in further detail below.

As an example, the computer-implemented method for designing at least one shaped body may comprise once or repeatedly performing one or more than one or even all of the method steps of the method for designing at least one shaping tool. Specifically, the computer-implemented method for designing at least one shaping tool may comprise performing steps i) to v), preferably in the given order. However, a different order may also be possible. Thus, regarding the optional performance of the method steps of the method for designing at least one shaping tool in the method for designing at least one shaped body, reference may be made to the description of the computer-implemented method for designing at least one shaping tool as outlined above and/or as described in further detail below.

Specifically, the computer-implemented method for designing at least one shaping tool may be or may function as a boundary condition and/or constraint for the designing of the at least one shaped body. Thus, as an example, the shaping target criteria, retrieved in step i), may specifically comprise at least one suitability of the shaping tool for shaping the at least one shaped body, specifically the shaped body having the lead candidate geometry determined in step e).

In a further aspect of the present invention, a use of a shaped body having a lead candidate geometry designed according to the computer-implemented method for designing at least one shaped body in a chemical process is disclosed. Therein, specifically, the shaped body may be an adsorbent. Alternatively, the shaped body may be a catalyst and the chemical process may comprise a catalytic reaction with said catalyst.

In a further aspect of the present invention, a process for the production of the shaped body having a lead candidate geometry designed according to the computer-implemented method for designing at least one shaped body is disclosed. Therein, specifically, the shaped body may be an adsorbent. Alternatively, the shaped body may be a catalyst.

In a further aspect of the invention, a computer-implemented method for designing a manufacturing process for manufacturing at least one shaped body is disclosed. The method may also be referred to as manufacturing process designing method. The method comprises the following steps, which may be performed in the given order. However, a different order may also be possible. Further one or more than one or even all of the steps may be performed once or repeatedly. Further, the method steps may be performed in a timely overlapping fashion or even in parallel. The method may further comprise additional method steps which are not listed.

The computer-implemented method for designing a manufacturing process comprises the following steps:
I) designing the shaped body by using the designing method, specifically the computer-implemented method for designing at least one shaped body as described above or as described in further detail below, thereby determining at least one lead candidate geometry of the shaped body; and
II) designing at least one shaping tool for manufacturing the shaped body by using the shaping tool designing method, specifically the computer-implemented method for designing at least one shaping tool as described above or as disclosed in further detail below, and by using at least one negative geometry of the at least one lead candidate geometry determined in step I) as a starting geometry.

The method for designing a manufacturing process for manufacturing at least one shaped body may be used for designing at least one manufacturing process, such as a granulation process and/or a tableting process, e.g. a spray drying process, and/or an extrusion process and/or a molding process and/or an additive manufacturing process. In particular, the method for designing a manufacturing process may be used for designing at least one manufacturing process comprising a production of at least one catalyst, specifically a catalyst pellet, e.g. a geometry of the at least one catalyst and/or catalyst pellet, and/or a production of at least one adsorbent, specifically an adsorbent pellet, a geometry of the at least one adsorbent and/or adsorbent pellet.

The term “designing a manufacturing process” as used herein is a broad term and is to be given its ordinary and customary meaning to a person of ordinary skill in the art and is not to be limited to a special or customized meaning. The term specifically may refer, without limitation, to a procedure of planning and/or specifying at least one manufacturing process. In particular, the designing of a manufacturing process may specifically be or may comprise developing or defining at least one setting or sequence of the manufacturing process, such as, for example, a sequence of manufacturing steps to be performed and/or a setting of one or more manufacturing variable.

Further, the manufacturing process designing method may comprise:

III) prototyping the at least one shaping tool from at least one geometry of the shaping tool designed in step II).

In particular, as an example, in step III) at least one prototyping process as described above may be used. Thus, specifically, in step III) at least one process may be used, wherein the process may be selected from the group consisting of: a rapid prototyping process, specifically an additive manufacturing process, more specifically one or more of a 3D printing process or an additive layer manufacturing process; a conventional prototyping process, e.g. a subtractive prototyping process; a spark erosion process. However, additionally or alternatively, any other prototyping process may be used for prototyping the at least one shaping tool in step III).

Step III) may specifically comprise prototyping a plurality of shaping tools, wherein the shaping tools may, for example, differ in one or more of: geometry, material and surface property.

The manufacturing process designing method may further comprise:

IV) manufacturing the at least one shaped body from the prototyped shaping tool.

In particular, the shaping tool, such as the shaping tool designed in step II) and prototyped in step III) of the manufacturing process designing method, may be used for manufacturing the shaped body, such as the shaped body designed in step I) of the manufacturing process designing method.

The manufacturing process designing method may further comprise:

V) experimentally validating one or more of the shaped body and the shaping tool.

Specifically, at least one of the shaped bodies experimentally validated in step V) may be the shaped body manufactured in step IV) by using the prototyped shaping tool. Thus, as an example, the shaping tool may be validated by comparing at least one property pf the shaped body with at least one property of the simulated shaped body.

Step V) may further comprise comparing at least one property of the shaped body manufactured in step IV) with a property of the at least one lead candidate determined in step I). Specifically, step V) may comprise comparing a geometry of the manufactured shaped body with the at least one lead candidate geometry.

Step V) may further comprise comparing at least one property of the prototyped shaping tool with a property of a simulated shaping tool determined in step II). Specifically, step V) may comprise comparing at least one geometry of the prototyped shaping tool with the geometry of the shaping tool determined in step II).

The manufacturing process designing method may further comprise:

VI) transferring information within the method.

In particular, the information transferred in step VI) may, for example, be selected from the group consisting of: at least one target criteria, specifically a set of target criteria, such as an expected property of the shaped body; a shaping target criteria, such as an expected property or setting of the shaping process; at least one lead candidate geometry of the shaped body; at least one specification of the shaped body, specifically at least one technical drawing of the shaped body, a three dimensional model of the shaped body, such as a digital three dimensional model of the shaped body; at least one specification of the shaping tool, specifically at least one technical drawing of the shaping tool, a three dimensional model of the shaping tool, such as a digital three dimensional model of the shaping tool; at least one actual property of the shaped body, such as a measured property of the shaped body; at least one actual setting of the shaping process and/or the tooling-manufacturing process.

In a further aspect of the invention a computer program for designing at least one shaped body is disclosed. The computer program is configured for causing a computer or computer network to fully or partially perform the method for designing at least one shaped body, e.g. the designing method, as described above or as described in further detail below, when the computer program is executed on the computer or computer network. For possible definitions of the terms used herein, reference may be made to the description of the designing method according to one or more of the embodiments disclosed herein.

As an example, the computer program may be configured to perform at least steps d) and e) of the method for designing at least one shaped body, e.g. of the designing method, as described above or as described in further detail below.

In a further aspect of the invention a computer program for designing at least one shaping tool is disclosed. The computer program is configured for causing a computer or computer network to fully or partially perform the method for designing at least one shaping tool, e.g. the shaping tool designing method, as described above or as described in further detail below, when the computer program is executed on the computer or computer network. For possible definitions of the terms used herein, reference may be made to the description of the shaping tool designing method according to one or more of the embodiments disclosed herein.

Specifically, the computer program may be configured to perform at least steps iv) and v) of the method for designing at least one shaping tool, e.g. of the shaping tool designing method, as described above or as described in further detail below.

In a further aspect of the invention, a computer program for designing at least one manufacturing process for manufacturing at least one shaped body is disclosed. The computer program is configured for causing a computer or computer network to fully or partially perform the method for designing a manufacturing process for manufacturing at least one shaped body, e.g. the manufacturing process designing method, as described above or as described in further detail below, when the computer program is executed on the computer or computer network. For possible definitions of the terms used herein, reference may be made to the description of the designing method, the shaping tool designing method and the manufacturing process designing method as disclosed in one or more of the embodiments disclosed herein.

Specifically, one, more than one or even all of the computer programs for designing at least one shaped body, for designing at least one shaping tool and for designing at least one manufacturing process may be stored on a computer-readable data carrier and/or on a computer-readable storage medium. As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Further disclosed and proposed herein is a computer program product comprising instructions which, when the program is executed by a computer or computer system, cause the computer or computer system to carry out one, more than one or even all of the computer-implemented methods for designing at least one shaped body, for designing at least one shaping tool and for designing at least one manufacturing process as described above or as described in further detail below. Thus, for possible definitions of the terms used herein, again reference may be made to the description of the designing method, the shaping tool designing method and the manufacturing process designing method according to one or more of the embodiments disclosed herein.

In particular, the computer program product may comprise program code means stored on a computer-readable data carrier, in order to perform the designing method, the shaping tool designing methods and/or the manufacturing process designing method as described above or as described in further detail below, when the program is executed on a computer or computer network. As used herein, the computer program product refers to the program as a tradable product. The product may generally exist in an arbitrary form, such as in a paper format, or on a computer-readable data carrier. Specifically, the computer program product may be distributed over a data network.

In a further aspect of the present invention a designing system for designing at least one shaped body is disclosed. The designing system comprises:
A. at least one interface configured for retrieving at least one set of target criteria for the shaped body;
B. at least one geometry defining unit configured for defining at least one seed geometry for the shaped body;
C. at least one parameter generating unit configured for generating a set of parameters comprising at least one geometry parameter of the seed geometry;
D. at least one simulation unit configured for simulating the shaped body by varying values of the set of parameters and by comparing simulated criteria for these values with the set of target criteria, thereby generating at least one adapted set of parameters for which the target criteria are fulfilled at least within predetermined tolerances; and
E. at least one lead candidate geometry defining unit configured for determining at least one lead candidate geometry of the at least one shaped body from the adapted set of parameters.

In particular, the designing system may, for example, be configured for performing the method for designing at least one shaped body, e.g. the designing method, as described above or as described in further detail below. Thus, for possible definitions of most of the terms used herein, reference may be made to the description of the designing method according to one or more of the embodiments disclosed herein.

In a further aspect of the present invention a shaping tool designing system for designing at least one shaping tool is disclosed. The shaping tool designing system comprises:
u. at least one interface configured for retrieving at least one set of shaping target criteria for the shaping tool;
v. at least one geometry defining unit configured for defining at least one starting geometry for the shaping tool;
w. at least one shaping parameter generating unit configured for generating a set of shaping parameters comprising at least one shape geometry parameter of the starting geometry;
x. at least one simulation unit configured for simulating a shaping process using the shaping tool by varying values of the set of shaping parameters and by comparing simulated shaping properties for these values with the set of shaping target criteria, thereby generating at least one adapted set of shaping parameters for which the shaping target criteria are fulfilled at least within predetermined tolerances; and
y. at least one shaping tool geometry defining unit configured for determining at least one geometry of the at least one shaping tool from the adapted set of shaping parameters.

Specifically, the shaping tool designing system may, for example, be configured for performing the method for designing at least one shaping tool, e.g. the shaping tool designing method, as described above or as described in further detail below. Thus, for possible definitions of most of the terms used herein, reference may be made to the description of the shaping tool designing method according to one or more of the embodiments disclosed herein.

In particular, the shaping tool designing system may further comprise at least one prototyping unit configured for prototyping the at least one shaping tool from the at least one geometry of the shaping tool defined by the at least one shaping tool geometry defining unit.

In a further aspect of the present invention a manufacture-designing system for designing a manufacturing process for manufacturing at least one shaped body is disclosed. The manufacture-designing system comprises:
the designing system; and
the shaping tool designing system.

In particular, the manufacture-designing system comprises the designing system and the shaping tool designing system as described above or as described in further detail below. Thus, for possible definitions of most of the terms used herein, reference may be made to the description of the designing method and the shaping tool designing method according to one or more of the embodiments disclosed herein.

Further, the manufacture-designing system may specifically be configured for performing the method for designing a manufacturing process for manufacturing at least one shaped body, e.g. the manufacturing process designing method, as described above or as described in further detail below. Thus, for possible definitions of most of the terms used herein, reference may be made to the description of the manufacturing process designing method according to one or more of the embodiments disclosed herein.

The methods, systems, and programs of the present invention have numerous advantages over methods, systems and programs known in the art. In particular, the methods, systems and programs as disclosed herein may allow for a reduction of research lead times and costs when designing at least one shaped body, at least one shaping tool and at least one manufacturing process for manufacturing at least one shaped body. As an example, research lead times and costs may be reduced when defining catalyst geometries. Further, shaped bodies, e.g. geometries of shaped bodies, may be created with competitive advantage due to an easier manufacturing and/or a better performance of an application, such as an application of the shaped body.

Further, the methods, systems and programs as disclosed herein may establish a workflow which allows faster and/or more cost effective definition of at least one shaped body, e.g. of geometries of the at least one shaped body. In particular, the methods, systems and programs as disclosed herein may provide a fast and efficient identification of at least one shaped body, e.g. a geometry of the at least one shaped body, such as a new shaped body, and identification of at least one shaping tool, specifically of at least one die e.g. of at least one geometry of the at least one die or shaping tool, and an identification of at least one manufacturing process, e.g. comprising shaping settings, all of which fulfill predetermined criteria, such as boundary conditions and/or targeted values.

In particular, the methods, systems and programs as disclosed herein, may allow to substantially lower production costs for shaped bodies. Further, the methods, systems and programs as disclosed herein may allow raising performance for the individual shaped body, for example by allowing for a more precise structuring and/or a more complex geometry, e.g. catalyst bodies. In addition, the methods, systems and programs as disclosed herein may allow differentiating catalyst performance which may be unlocked, for example, by optimized geometry. Further, catalyst production costs may be reduced, e.g. due to higher yields and efficiency of manufacturing shaped bodies.

In particular, the methods, systems and programs as disclosed herein, may establish a workflow which allows a faster and/or more cost effective definition of shaped bodies, e.g. geometries of shaped bodies, for example especially for heterogeneous catalysts but not exclusively. Specifically, the methods, systems and programs may comprise computer simulations and optimizations, prototyping of catalyst shaping tools and experimental inputs and experimented meditations.

Summarizing and without excluding further possible embodiments, the following embodiments may be envisaged:

Embodiment 1. A computer-implemented method for designing at least one shaped body, the method comprising:
a) retrieving at least one set of target criteria for the shaped body;
b) defining at least one seed geometry for the shaped body;
c) generating a set of parameters comprising at least one geometry parameter of the seed geometry;
d) simulating the shaped body by varying values of the set of parameters and by comparing simulated criteria for these values with the set of target criteria, thereby generating at least one adapted set of parameters for which the target criteria are fulfilled at least within predetermined tolerances; and
e) determining at least one lead candidate geometry of the at least one shaped body from the adapted set of parameters.

Embodiment 2. The method according to the preceding embodiment, wherein the set of target criteria in step a) is retrieved via at least one interface, specifically via at least one web interface.

Embodiment 3. The method according to the preceding embodiment, wherein the at least one lead candidate geometry of the shaped body is output via the at least one interface.

Embodiment 4. The method according to any one of the preceding embodiments, wherein the target criteria contain at least one constraint selected from the group consisting of: a geometry constraint, such as a production machine tolerance, a wall minimum thickness, a tabletability constraint, an extrudability constraint, a maximum diameter constraint, a maximum height constraint; a weight constraint; a surface area constraint; a density constraint; a mechanical strength constraint; a pressure drop constraint; a heat transport constraint; a mass transport constraint; a productivity constraint; a shaping process constraint.

Embodiment 5. The method according to any one of the preceding embodiments, wherein at least one of the target criteria of the set of target criteria comprises at least one condition to be fulfilled by the shaped body.

Embodiment 6. The method according to the preceding embodiment, wherein the condition is a condition to be fulfilled by a measurable property of the shaped body.

Embodiment 7. The method according to the preceding embodiment, wherein the measurable property is selected from the group consisting of: a geometry parameter of the shaped body; a weight of the shaped body; a surface area of the shaped body; a density of the shaped body; a pore structure of the shaped body; a mechanical strength of the shaped body; a pressure drop parameter; a heat transport parameter; a mass transport parameter; a productivity parameter; a elasticity property of a material of the shaped body, specifically a Young module of a material of the shaped body; a shape property, such as a side crush strength, a bulk crush strength, a tensile strength; a chemical conversion parameter, such as a reaction rate, a chemical conversion, a reaction yield, a reaction selectivity, a conveying parameter, such as a flow index.

Embodiment 8. The method according to any one of the two preceding embodiments, wherein one or both of a test and a verification if the condition is fulfilled comprises a comparison of the measurable property with at least one numerical value, specifically with at least one of: a single numerical value, specifically a threshold value; a plurality of numerical values, specifically a range; a target value.

Embodiment 9. The method according to any one of the four preceding embodiments, wherein the condition is a condition to be fulfilled by a qualitative property of the shaped body.

Embodiment 10. The method according to any one of the preceding embodiments, wherein the target criteria comprise at least one suitability of the shaped body for at least one predetermined application purpose, specifically at least one of a suitability for application in a predetermined reactor, a suitability for application under a predetermined pressure, a suitability for application at a predetermined temperature, a suitability for application with at least one predetermined reactant, a suitability for application in a predetermined reaction, a suitability for application under at least one predetermined flow condition, a suitability for application in at least one predetermined mass flow.

Embodiment 11. The method according to any one of the preceding embodiments, wherein step a) further comprises weighing the target criteria.

Embodiment 12. The method according to any one of the preceding embodiments, wherein step a) further comprises retrieving at least one information on a material to be used for the shaped body.

Embodiment 13. The method according to any one of the preceding embodiments, wherein the adapted set of parameters in step d) is generated by applying at least one operation selected from the group consisting of: a non-linear algorithm; a stochastic algorithm; a genetic algorithm; an artificial intelligence algorithm; a gradient-based algorithm; a multi-criteria optimization function, specifically at least one of a weighted sum function or an ε-constraint function; sequential quadratic programming; method of feasible directions; quasi-newton method; newton method.

Embodiment 14. The method according to any one of the preceding embodiments, wherein step d) further comprises simulating the shaped body by varying values of the adapted set of parameters.

Embodiment 15. The method according to any one of the preceding embodiments, wherein the shaped body is an element selected from the group consisting of: a packed bed material, such as a packed bed material used in a scrubbing tower or scrubber; a tower packing, such as a wash tower packing; a catalyst, more specifically a catalyst pellet; an adsorbent, more particularly an adsorbent pellet.

Embodiment 16. The method according to any one of the preceding embodiments, further comprising a computer-implemented designing of at least one shaping tool for manufacturing the shaped body, the computer-implemented method for designing the at least one shaping tool comprising:
i) retrieving, by using at least one interface, at least one set of shaping target criteria for the shaping tool;
ii) defining, by using at least one geometry defining unit, at least one starting geometry for the shaping tool, wherein at least one negative geometry of the at least one lead candidate geometry determined in step e) is used as the starting geometry;
iii) generating, by using at least one shaping parameter generating unit, a set of shaping parameters comprising at least one shape geometry parameter of the starting geometry;
iv) simulating, by using at least one simulation unit, a shaping process using the shaping tool by varying values of the set of shaping parameters and by comparing simulated shaping properties for these values with the set of shaping target criteria, thereby generating at least one shaping geometry with an adapted set of shaping parameters for which the shaping target criteria are fulfilled at least within predetermined tolerances; and
v) determining, by using at least one shaping tool geometry defining unit, at least one geometry of the at least one shaping tool from the adapted set of shaping parameters.

Embodiment 17. The method according to the preceding embodiment, wherein the shaping target criteria comprise at least one suitability of the shaping tool for shaping the at least one shaped body, specifically the shaped body with the lead candidate geometry determined in step e).

Embodiment 18. The method according to any one of the two preceding embodiments, wherein the shaping target criteria contain at least one constraint selected from the group consisting of: a surface property constraint; a geometry constraint; a pressure constraint; a shear force constraint; a compaction force constraint; an ejection force constraint; a productivity constraint; a force distribution constraint; a velocity distribution constraint; a mechanical stability constraint; a strength constraint, such as a tensile strength constraint; a pore size constraint; a weight constraint; an attrition performance constraint; a production machine constraint; a production constraint.

Embodiment 19. The method according to any one of the three preceding embodiments, wherein at least one of the shaping target criteria of the set of shaping target criteria comprises at least one condition to be fulfilled by the shaping tool.

Embodiment 20. The method according to any one of the four preceding embodiments, wherein the adapted set of parameters in step iv) is generated by applying at least one operation selected from the group consisting of a non-linear algorithm; a stochastic algorithm; a genetic algorithm; an artificial intelligence algorithm; a gradient-based algorithm; a multi-criteria optimization function; sequential quadratic programming; method of feasible directions; quasi-newton method; newton method.

Embodiment 21. Use of a shaped body having a lead candidate geometry designed according to the computer-implemented method for designing at least one shaped body according to any one of the preceding embodiments in a chemical process.

Embodiment 22. The use according to the preceding embodiment, wherein the shaped body is an adsorbent.

Embodiment 23. The use according to embodiment 21, wherein the shaped body is a catalyst and the chemical process comprises a catalytic reaction with said catalyst.

Embodiment 24. Process for the production of a shaped body (112) having a lead candidate geometry designed according to the computer-implemented method for designing at least one shaped body (112) according to any one of embodiments 1 to 20.

Embodiment 25. The process for the production according to the preceding embodiment, wherein the shaped body is an adsorbent.

Embodiment 26. The process for the production according to embodiment 24, wherein the shaped body is a catalyst.

Embodiment 27. A computer-implemented method for designing a manufacturing process for manufacturing at least one shaped body, the method comprising:
I) designing the shaped body by using the method according to any one of the preceding embodiments referring to a method for designing at least one shaped body, thereby determining at least one lead candidate geometry of the shaped body; and
II) designing at least one shaping tool for manufacturing the shaped body by using a computer-implemented method for designing at least one shaping tool, the computer-implemented method for designing the at least one shaping tool comprising:
   i) retrieving at least one set of shaping target criteria for the shaping tool;
   ii) defining at least one starting geometry for the shaping tool, wherein at least one negative geometry of the at least one lead candidate geometry determined in step I) is used as the starting geometry;
   iii) generating a set of shaping parameters comprising at least one shape geometry parameter of the starting geometry;
   iv) simulating a shaping process using the shaping tool by varying values of the set of shaping parameters and by comparing simulated shaping properties for these values with the set of shaping target criteria, thereby generating at least one shaping geometry with an adapted set of shaping parameters for which the shaping target criteria are fulfilled at least within predetermined tolerances; and
   v) determining at least one geometry of the at least one shaping tool from the adapted set of shaping parameters.

Embodiment 28. The method according to the preceding embodiment, wherein the shaping tool is one or more of a tableting tool and an extrusion die.

Embodiment 29. The method according to the preceding embodiment, wherein the shaping target criteria comprise at least one suitability of the shaping tool for shaping at least one predetermined object.

Embodiment 30. The method according to the preceding embodiment, wherein the predetermined object is the shaped body designed by using the method according to any one of the preceding embodiments referring to a method for designing at least one shaped body.

Embodiment 31. The method according to any one of the three preceding embodiments, wherein the set of shaping target criteria in step i) is retrieved via at least one interface, specifically via at least one web interface.

Embodiment 32. The method according to the preceding embodiment, wherein the at least one geometry of the shaping tool is output via the at least one interface.

Embodiment 33. The method according to any one of the five preceding embodiments, wherein the shaping target criteria contain at least one constraint selected from the group consisting of: a surface property constraint; a geometry constraint, specifically a geometry constraint of an object to be shaped by using the shaping tool; a pressure constraint; a shear force constraint; a compaction force constraint; an ejection force constraint; a die-filling constraint; a productivity constraint; an economic constraint, e.g. a price and/or a profit margin; a force distribution constraint; a velocity distribution constraint; a mechanical stability constraint; a strength constraint, such as a tensile strength constraint; a pore size constraint; a weight constraint; an attrition performance constraint; a production machine constraint, e.g. a dimension of the production machine; a production constraint, e.g. a limitation for the design due to the production technology.

Embodiment 34. The method according to any one of the six preceding embodiments, wherein at least one of the shaping target criteria of the set of shaping target criteria comprises at least one condition to be fulfilled by the shaping tool.

Embodiment 35. The method according to the preceding embodiment, wherein the condition is a condition to be fulfilled by a measurable property of the shaping tool, such as by a performance of the shaping tool, specifically one of more of: if the shaping tool is suited for manufacturing the shaped body, e.g. suited for providing and/or withstanding a predefined sheer stress and/or pressure drop across the shaping tool, e.g. across the die, and/or an ejection force, specifically an ejection force of a tableting tool, lifetime in process, productivity, e.g. a minimum productivity measured for example in kilogram per hour [kg/h], a yield, such as a maximum yield, e.g. a minimal quantity of production rejects.

Embodiment 36. The method according to the preceding embodiment, wherein the measurable property of the shaping tool is selected from the group consisting of: a surface parameter of the shaping tool; a geometry parameter of the shaping tool; a geometry parameter of an object to be shaped by using the die; a pressure parameter; a shear force; a compaction force; an ejection force; a productivity parameter; a property of a material of an object to be shaped by using the die, specifically a viscosity, a powder bulk density, a compressibility, a compactability and a compressibility-compactability curve, a cohesion; a flowability; a particle size distribution; a crush strength of primary particles.

Embodiment 37. The method according to any one of the two preceding embodiments, wherein one or both of a test and a verification if the condition is fulfilled comprises a comparison of the measurable property with at least one numerical value, specifically with at least one of: a single numerical value, specifically a threshold value; a plurality of numerical values, specifically a range; a target value.

Embodiment 38. The method according to any one of the ten preceding embodiments, wherein step i) further comprises weighing the target criteria.

Embodiment 39. The method according to any one of the eleven preceding embodiments, wherein step i) further comprises retrieving at least one material to be shaped by the shaping tool, e.g. retrieving at least one material property of the at least one material to be shaped by the shaping tool.

Embodiment 40. The method according to any one of the twelve preceding embodiments, wherein step iv) further comprises simulating the shaping process using the adapted set of shaping parameters.

Embodiment 41. The method according to any one of the thirteen preceding embodiments, wherein the adapted set of parameters in step iv) is generated by applying at least one operation selected from the group consisting of a non-linear algorithm; a stochastic algorithm; a genetic algorithm; an artificial intelligence algorithm; a gradient-based algorithm; a multi-criteria optimization function, specifically at least one of a weighted sum function or an ε-constraint function; sequential quadratic programming; method of feasible directions; quasi-newton method; newton method.

Embodiment 42. The method according to any one of the fourteen preceding embodiments, wherein the method of step II) further comprises:
vi) prototyping the at least one shaping tool from the at least one geometry of the shaping tool determined in step v).

Embodiment 43. The method according to the preceding embodiment, wherein in step vi) at least one process is used, selected from the group consisting of: a rapid prototyping process, specifically an additive manufacturing process, more specifically one or more of a 3D printing process or an additive layer manufacturing process; a conventional prototyping process, e.g. a subtractive prototyping process; a spark erosion process.

Embodiment 44. The method according to any one of the two preceding embodiments, wherein the method further comprises:
vii) validating the prototyped shaping tool by comparing at least one property of the prototyped shaping tool with at least one property of a simulated shaping tool.

Embodiment 45. The method according to any one of the seventeen preceding embodiments, wherein the method further comprises:
III) prototyping the at least one shaping tool from at least one geometry of the shaping tool designed in step II).

Embodiment 46. The method according to the preceding embodiment, wherein in step III) at least one process according to embodiment 31 is used.

Embodiment 47. The method according to any one of the two preceding embodiments, wherein step III) comprises prototyping a plurality of shaping tools, wherein the shaping tools differ in one or more of: geometry, material and surface property.

Embodiment 48. The method according to any one of the three preceding embodiments, wherein the method further comprises:
IV) manufacturing the at least one shaped body from the prototyped shaping tool.

Embodiment 49. The method according to any one of the five preceding embodiments, wherein the method further comprises:
V) experimentally validating one or more of the shaped body and the shaping tool.

Embodiment 50. The method according to the two preceding embodiments, wherein at least one of the shaped bodies experimentally validated in step V) is the shaped body manufactured in step IV) by using the prototyped shaping tool.

Embodiment 51. The method according to the preceding embodiment, wherein step V) further comprises comparing at least one property of the shaped body manufactured in step IV) with a property of the at least one lead candidate determined in step I), specifically comparing a geometry of the manufactured shaped body with the at least one lead candidate geometry.

Embodiment 52. The method according to embodiments 33 and 37, wherein step V) further comprises comparing at least one property of the prototyped shaping tool with a property of a simulated shaping tool determined in step II), specifically comparing at least one geometry of the prototyped shaping tool with the geometry of the shaping tool determined in step II)

Embodiment 53. The method according to any one of the twenty-six preceding embodiments, wherein the method further comprises:
VI) transferring information within the method.

Embodiment 54. The method according to the preceding embodiment, wherein the information transferred in step VI) is selected from the group consisting of: at least one target criteria, specifically a set of target criteria, such as an expected property of the shaped body; a shaping target criteria, such as an expected property or setting of the shaping process; at least one lead candidate geometry of the shaped body; at least one specification of the shaped body, specifically at least one technical drawing of the shaped body, a three dimensional model of the shaped body, such as a digital three dimensional model of the shaped body; at least one specification of the shaping tool, specifically at least one technical drawing of the shaping tool, a three dimensional model of the shaping tool, such as a digital three dimensional model of the shaping tool; at least one actual property of the shaped body, such as a measured property of the shaped body; at least one actual setting of the shaping process and/or the tooling-manufacturing process.

Embodiment 55. A computer program for designing at least one shaped body, configured for causing a computer or computer network to at least partially perform the method according to any one the preceding embodiments, when executed on the computer or computer network.

Embodiment 56. The computer program according to the preceding embodiment, wherein the computer program is configured to perform at least steps d) and e) of the method.

Embodiment 57. The computer program according to any one of the two preceding embodiments, wherein the computer program is configured to perform at least steps iv) and v) of the method according to any one of embodiments 16 to 42.

Embodiment 58. A designing system for designing at least one shaped body, the designing system comprising:
A. at least one interface configured for retrieving at least one set of target criteria for the shaped body;
B. at least one geometry defining unit configured for defining at least one seed geometry for the shaped body;
C. at least one parameter generating unit configured for generating a set of parameters comprising at least one geometry parameter of the seed geometry;
D. at least one simulation unit configured for simulating the shaped body by varying values of the set of parameters and by comparing simulated criteria for these values with the set of target criteria, thereby generating at least one adapted set of parameters for which the target criteria are fulfilled at least within predetermined tolerances; and
E. at least one lead candidate geometry defining unit configured for determining at least one lead candidate geometry of the at least one shaped body from the adapted set of parameters.

Embodiment 59. The designing system according to the preceding embodiment, wherein the designing system is configured for performing the method according to any one of the preceding embodiments referring to a method for designing at least one shaped body.

Embodiment 60. A manufacture-designing system for designing a manufacturing process for manufacturing at least one shaped body, the manufacture-designing system comprising the designing system according to any one of embodiments 46 to 47 and at least one shaping tool designing system for designing at least one shaping tool, the shaping tool designing system comprising:
u. at least one interface configured for retrieving at least one set of shaping target criteria for the shaping tool;
v. at least one geometry defining unit configured for defining at least one starting geometry for the shaping tool;
w. at least one shaping parameter generating unit configured for generating a set of shaping parameters comprising at least one shape geometry parameter of the starting geometry;
x. at least one simulation unit configured for simulating a shaping process using the shaping tool by varying values of the set of shaping parameters and by comparing simulated shaping properties for these values with the set of shaping target criteria, thereby generating at least one adapted set of shaping parameters for which the shaping target criteria are fulfilled at least within predetermined tolerances; and
y. at least one shaping tool geometry defining unit configured for determining at least one geometry of the at least one shaping tool from the adapted set of shaping parameters.

Embodiment 61. The manufacture-designing system according to the preceding embodiment, wherein the designing system is configured for performing the method according to any one of embodiments 16 to 42.

Embodiment 62. The manufacture-designing system according to any one of the two preceding embodiments, wherein the system further comprises at least one prototyping unit configured for prototyping the at least one shaping tool from the at least one geometry of the shaping tool defined by the at least one shaping tool geometry defining unit.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1: shows a flow chart of an embodiment of a method for designing at least one shaped body;

FIG. 2: shows a flow chart of an embodiment of a method for designing at least one shaping tool;

FIGS. 3A to 3C: show flow charts of different embodiments of a method for designing a manufacturing process for manufacturing at least one shaped body;

FIG. 4: shows an embodiment of a designing system for designing at least one shaped body;

FIG. 5: shows an embodiment of a designing system for designing at least one shaping tool;

FIGS. 6A to 6C: show flow charts of different embodiments of a method for designing a manufacturing process for manufacturing at least one shaped body;

FIG. 7: shows different embodiments of a shaped body arranged in a diagram;

FIG. 8A: shows an embodiment of a shaped body in a perspective view;

FIG. 8B: shows a perspective view of an embodiment of a shaping tool for manufacturing the shaped body illustrated in FIG. 8A;

FIG. 9A: shows an embodiment of a shaped body in a perspective view;

FIG. 9B: shows a section view of an embodiment of a shaping tool for manufacturing the shaped body illustrated in FIG. 9A;

FIGS. 10A to 10D: show different embodiments of a shaping tool each in a perspective view and in a section view;

FIGS. 11A to 11D: show different embodiments of a shaping tool in a perspective view;

FIGS. 12A to 12D: show different embodiments of a shaped body manufactured by respectively using the shaping tool illustrated in FIGS. 11A to 11D; and

FIGS. 13A to 13D: show different embodiments of a shaping tool in a section view.

### DETAILED DESCRIPTION OF THE EMBODIMENTS

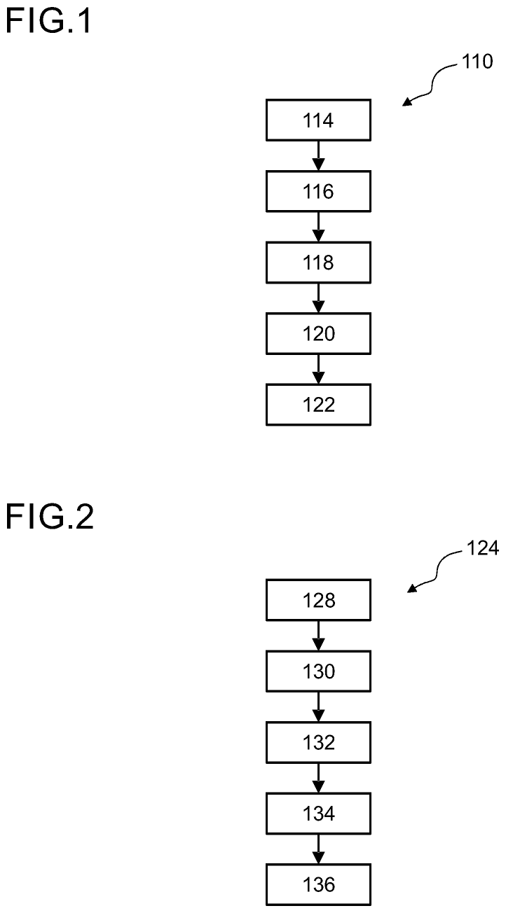

In FIG. 1 a flow chart of a computer-implemented method 110 for designing at least one shaped body 112 is illustrated. The computer-implemented method 110 for designing at least one shaped body on the 112, e.g. the designing method 110, comprises the following steps, which may specifically be performed in the given order. Still, a different order may also be possible. It may be possible to perform two or more of the method steps fully or partially simultaneously. It may further be possible to perform one, more than one or even all of the method steps once or repeatedly. The method may comprise additional method steps which are not listed herein. The method steps of the designing method 110 are the following:
a) (denoted with reference number 114) retrieving at least one set of target criteria for the shaped body 112;
b) (denoted with reference number 116) defining at least one seed geometry for the shaped body 112;
c) (denoted with reference number 118) generating a set of parameters comprising at least one geometry parameter of the seed geometry;
d) (denoted with reference number 120) simulating the shaped body 112 by varying values of the set of parameters and by comparing simulated criteria for these values with the set of target criteria, thereby generating at least one adapted set of parameters for which the target criteria are fulfilled at least within predetermined tolerances; and
e) (denoted with reference number 122) determining at least one lead candidate geometry of the at least one shaped body 112 from the adapted set of parameters.

In FIG. 2 a flow chart of a computer-implemented method 124 for designing at least one shaping tool 126 is illustrated. The computer-implemented method 124 for designing at least one shaping tool 126, e.g. the shaping tool designing method 124, comprises the following steps, which may specifically be performed in the given order. Still, a different order may also be possible. It may be possible to perform two or more of the method steps fully or partially simultaneously. It may further be possible to perform one, more than one or even all of the method steps once or repeatedly. The method may comprise additional method steps which are not listed herein. The method steps of the designing method 124 are the following:
i) (denoted with reference number 128) retrieving at least one set of shaping target criteria for the shaping tool 126;
ii) (denoted with reference number 130) defining at least one starting geometry for the shaping tool 126;
iii) (denoted with reference number 132) generating a set of shaping parameters comprising at least one shape geometry parameter of the starting geometry;
iv) (denoted with reference number 134) simulating a shaping process using the shaping tool 126 by varying values of the set of shaping parameters and by comparing simulated shaping properties for these values with the set of shaping target criteria, thereby generating at least one shaping geometry with an adapted set of shaping parameters for which the shaping target criteria are fulfilled at least within predetermined tolerances; and
v) (denoted with reference number 136) determining at least one geometry of the at least one shaping tool 126 from the adapted set of shaping parameters.

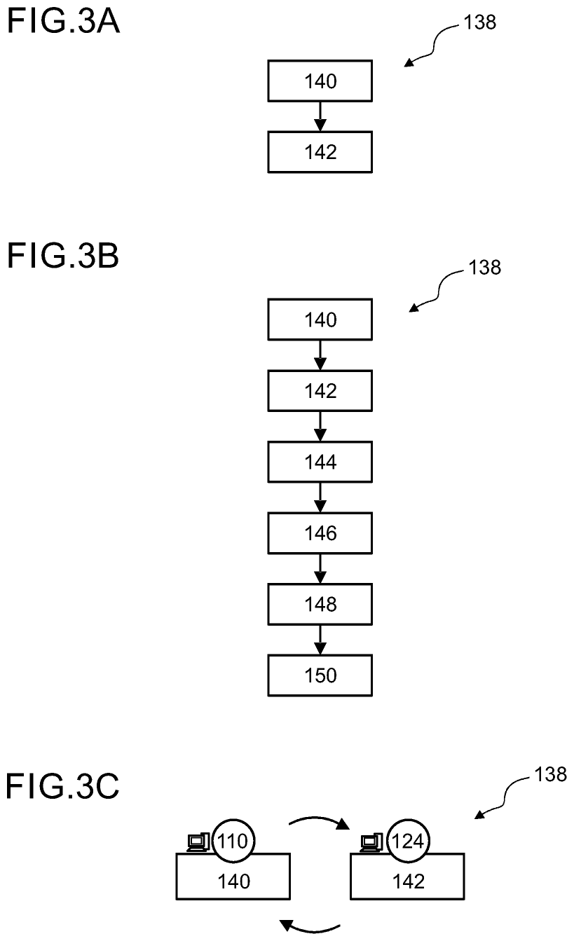

In FIG. 3A a flow chart of a computer-implemented method 138 for designing a manufacturing process for manufacturing at least one shaped body 112 is illustrated. The computer-implemented method for designing a manufacturing process for manufacturing at least one shaped body 112, e.g. the manufacturing process designing method 138, comprises the following steps, which may specifically be performed in the given order. Still, a different order may also be possible. It may be possible to perform two or more of the method steps fully or partially simultaneously. It may further be possible to perform one, more than one or even all of the method steps once or repeatedly. The method may comprise additional method steps which are not listed herein. The method steps of the designing method 138 are the following:
I) (denoted with reference number 140) designing the shaped body 112 by using the designing method 110, specifically the computer-implemented method 110 for designing at least one shaped body 112 as described above or as described in further detail below, thereby determining at least one lead candidate geometry of the shaped body 112; and
II) (denoted with reference number 142) designing at least one shaping tool 126 for manufacturing the shaped body 112 by using the shaping tool designing method 124, specifically the computer-implemented method 124 for designing at least one shaping tool 126 as described above or as disclosed in further detail below, and by using at least one negative geometry of the at least one lead candidate geometry determined in step I) 140 as a starting geometry.

Further, as for example shown in the flow chart of a manufacturing process designing method 138 illustrated in FIG. 3B, the manufacturing process designing method 138 may comprise additional steps. In particular, the manufacturing process designing method 138 may, for example, comprise the following further steps:
III) (denoted with reference number 144) prototyping the at least one shaping tool 126 from at least one geometry of the shaping tool 126 designed in step II);
IV) (denoted with reference number 146) manufacturing the at least one shaped body 112 from the prototyped shaping tool 126;
V) (denoted with reference number 148) experimentally validating one or more of the shaped body 112 and the shaping tool 126; and
VI) (denoted with reference number 150) transferring information within the method 138.

In FIG. 3C a flow chart of a different embodiment of a method 138 for designing a manufacturing process for manufacturing at least one shaped body 112 is shown. Specifically, as illustrated in the Figure, step I) 140 and step II) 142 may be performed iteratively. In particular, in step I) 140, the designing method 110, may be performed, wherein in step II) 142, the shaping tool designing method 124, may be performed. Thus, as an example, in step I) 140, the designing method 110, e.g. by simulating the shaped body in step d), may be used for defining the lead candidate geometry of the shaped body 112. As a further example, in step II) 142 the shaping tool designing method 124, e.g. by simulating a shaping process using the shaping tool 126 in step vi), may be used for optimizing the geometry of the shaping tool 126, e.g. of the shaping tool, required to produce at least one shaped body 112. In particular, step I) 140 and step II) 142, specifically the designing method 110 and the shaping tool designing method 124, may be performed individually and/or in combination, such as combined with each other, for example, in a feed-back loop. Thus, results from step I) 140, such as, for example, the lead candidate geometry for the shaped body 112, may be used in step II) 142. Additionally or alternatively, results from step II), such as, for example, the geometry of the shaping tool 126, may be used in step I) 140, specifically for generating the seed geometry. The designing method 110 and the shaping tool designing method 124 may be performed iteratively, such as to determine the shaping tool 126 and corresponding shaped body 112. Thus, as an example, the designing method 110 and the shaping tool designing method 124 may be performed iteratively until a best possible compromise between the target criteria for the shaped body 112 and the shaping target criteria for the shaping tool 126 may be found. In particular, more than one geometry of the shaping tool 126, such as a group of geometries of the shaping tool 126, may be determined, wherein subsequently, the most adequate geometry of the shaping tool 126 may be selected from the group of geometries of the shaping tool 126.

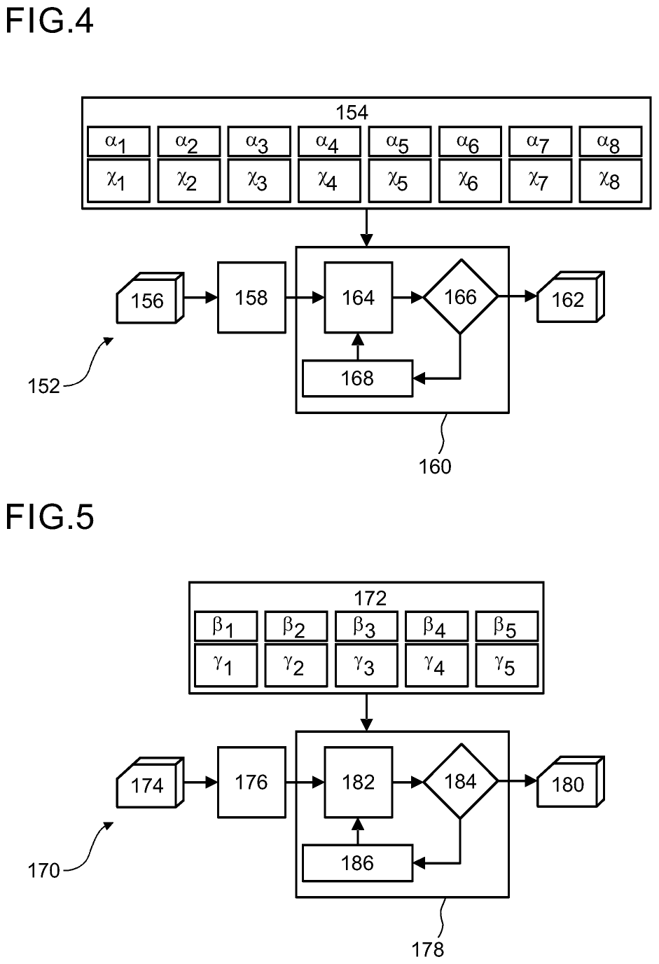

In FIG. 4, an embodiment of a designing system 152 for designing at least one shaped body 112 is illustrated in a front plane view. The designing system 152 comprises at least one interface 154 configured for retrieving at least one set of target criteria for the shaped body 112. Further, the designing system 152 comprises at least one geometry defining unit 156 configured for defining at least one seed geometry for the shaped body 112. Further, the designing system 152 comprises at least one parameter generating unit 158 configured for generating a set of parameters comprising at least one geometry parameter of the seed geometry. Further, the designing system 152 comprises at least one simulation unit 160 configured for simulating the shaped body 112 by varying values of the set of parameters and by comparing simulated criteria for these values with the set of target criteria, thereby generating at least one adapted set of parameters for which the target criteria are fulfilled at least within predetermined tolerances. Further, the designing system 152 comprises at least one lead candidate geometry defining unit 162 configured for determining at least one lead candidate geometry of the at least one shaped body from the adapted set of parameters.

The set of target criteria may comprise a plurality of target criteria, such as a first target criterion X₁, a second target criterion X₂, a third target criterion X₃, and so on. As illustrated in FIG. 4, as an example, the set of target criteria may comprise eight target criterion X₁ to X₈. In particular, the target criteria may be weighed. Thus, as further illustrated in FIG. 4, each target criterion X₁ to X₈, may be individually weighed, which may be illustrated by an added weight identification ai to as. In particular, for example when using a multi-criteria optimization, the weight of individual criteria, such as of individual target criterion of the set of target criteria, may be chosen freely, specifically to an extent that within the optimization function an individual target criterion of the set of target criteria may be fully considered, e.g. α=1, or fully discarded, e.g. α=0, or anything in between, e.g. 0<α<1.

As an example, the simulation unit 160 may be configured for simulating the shaped body 112. In FIG. 4, the simulating of the shaped body 112 may be illustrated by a first box 164 indicating the varying of values of the set of parameters, by a second box 166 indicating the comparing of the simulated criteria for these values with the set of target criteria, and by a third box 168 indicating an iterative performance of the simulation by feeding the varied values of the set of parameters back to the first box 164 such as to further vary the values. Thus, as illustrated, in the simulation unit 160, the values of the set of parameters may be varied iteratively until an adapted set of parameters may be found for which the target criteria are fulfilled at least within predetermined tolerances.

In particular, when designing at least one shaped body 112 with the designing system 152, a seed geometry may be described, for example, with geometric parameters. Further, the geometry defining unit 156 may be used for defining the seed geometry, e.g. a generated geometry. The seed geometry may then be evaluated by using the simulation unit 160 for performing simulations according to pre-defined performance criteria, such as by varying values of the set of parameters and by comparing simulated criteria for these values with the set of target criteria until an adapted set of parameters is generated for which the target criteria are fulfilled. In detail, as an example, according to the result of the comparison, the values of the set of parameters, e.g. the geometric parameters, may be varied in the simulation, e.g. during an optimization loop, in a way that firstly a new geometry may have a higher probability of fulfilling the pre-defined criteria, e.g. the target criteria, and secondly may reduce simulation resources and time. In particular, the optimization loop may be conducted until a best possible compromise among targets may be reached, wherein further target criteria, such as boundary conditions may be respected.

The target criteria may, for example, comprise constrains of geometry and weight. Thus, the target criteria may comprise pre-existing constrains of geometry, e.g. dimensions of existing shaping machines or existing application reactors, and weight, e.g. pre-existing constrain of a maximum and/or minimum weight inside application reactor. Further, the target criteria may, for example, comprise constrains of surface area, weight and density. Thus, the target criteria may comprise the geometric external surface area or weight of a single shaped body, the specific surface area of a single shaped body, e.g. a surface area divided by weight or its reciprocal, the surface or weight of the particles within reactor bed, the specific surface area of a reactor bed, e.g. a surface area of bed of shaped body divided by volume of empty reactor or its reciprocal, the loading density of a reactor bed, e.g. a weight of bed divided by surface area of bed or its reciprocal. Specifically, the target criteria may further include a BET surface area of a single particle or of the reactor bed, and/or the internal surface area of a single particle or of the reactor bed. Additionally or alternatively, the target criteria may include a pore structure of the shaped body or particle or of particles within the reactor bed. Further, the target criteria may for example include an accessible surface area of the reactor bed, i.e. when considering a blockage of the surface area due to the presence of other particles or reactor internal structure.

Additionally or alternatively, the target criteria may be or may comprise a mechanical strength. Thus, the target criteria may comprise a crushing strength, i.e. a compressive strength, a tensile strength, a shear strength, a bending strength, a torsion strength, a cutting strength, an attrition, an abrasion, an elasticity, a torsion strength, or the like. It may specifically be uniaxial, multiaxial, isotropic and/or anisotropic. As an example, the target criteria may comprise a mechanical strength in fixed and/or moving and/or fluidized bed, specifically a mechanical strength in cycles of mechanical stress, of thermal stress, e.g. an increase and/or a decrease in temperature, of transportation stress and/or vibration induced stress. As an example, the target criteria comprising the mechanical strength may be measured, e.g. from measurements conducted with a material of for the shaped body. In particular, these measurements conducted with an arbitrary object having an arbitrary geometry, such as for example a simple geometry, e.g. a cylinder. Additionally or alternatively, information on the mechanical strength may be taken from state-of-the-art literature.

Additionally or alternatively, the target criteria may be or may comprise a pressure drop, specifically a maximum and/or a minimum of pressure drop. Thus, the target criteria may comprise a pressure drop of a shaped body, specifically of a single shaped body and/or reactor bed, such as a reactor bed filled with shaped bodies. In particular, the pressure drop may be calculated by using, as an example, state-of-the-art mathematical correlations. Further, the pressure drop may be calculated and/or simulated by using, as an example, state-of-the-art tools such as computational fluid dynamics (CFD) and/or other methods. Specifically, the pressure drop may be calculated and/or simulated, for example, by using information on fluids and conditions, such as temperature, pressure and/or residence time, which may occur in a reactor. Additionally or alternatively, the pressure drop may be calculated and/or simulated, for example, by using estimated information on fluids and conditions. Additionally or alternatively, the pressure drop may be calculated and/or simulated, for example, by using similarity aspects, e.g. by estimating the pressure drop for similar geometries. These calculation and/or simulation approaches may, for example, allow for an absolute and/or relative comparison.

Additionally or alternatively, the target criteria may be or may comprise a heat transport, specifically a maximum and/or a minimum of heat transport. Thus, the target criteria may comprise a heat transport of a shaped body, specifically of a single shaped body and/or reactor bed, such as a reactor bed filled with shaped bodies. In particular, the heat transfer may be calculated by using, as an example, state-of-the-art mathematical correlations. Further, the heat transfer may be calculated and/or simulated by using, for example, state-of-the-art tools such as computational fluid dynamics (CFD), finite element method (FEM) and distinct element method (DEM), and/or other methods available. Specifically, the heat transport may be calculated and/or simulated, for example, by using information on fluids and conditions, such as temperature, pressure and/or residence time, which may occur in a reactor. Additionally or alternatively, the heat transport may be calculated and/or simulated, for example, by using estimated information on fluids and conditions. Additionally or alternatively, the heat transport may be calculated and/or simulated, for example, by using similarity aspects, e.g. by estimating the heat transport for similar geometries.

Additionally or alternatively, the target criteria may be or may comprise a mass transport, specifically a maximum and/or a minimum of mass transport. Thus, the target criteria may comprise a mass transport of a shaped body, specifically of a single shaped body and/or reactor bed, such as a reactor bed filled with shaped bodies. In particular, the mass transfer may be calculated by using, as an example, state-of-the-art mathematical correlations. Further, the mass transfer may be calculated and/or simulated by using, for example, state-of-the-art tools such as computational fluid dynamics (CFD), finite element method (FEM) and distinct element method (DEM), and/or other methods available. Specifically, the mass transport may be calculated and/or simulated, for example, by using information on fluids and conditions, such as temperature, pressure and/or residence time, which may occur in a reactor. Additionally or alternatively, the mass transport may be calculated and/or simulated, for example, by using estimated information on fluids and conditions. Additionally or alternatively, the mass transport may be calculated and/or simulated, for example, by using similarity aspects, e.g. by estimating the mass transport for similar geometries.

Additionally or alternatively, the target criteria may be or may comprise a productivity, specifically a minimum and/or a maximum productivity. The productivity may specifically be estimated by using existing data of similar geometries. Additionally or alternatively, the productivity may be calculated and/or simulated by using manufacturing information, e.g. on production machines, such as production lines, and/or on product properties, e.g. product properties which may be needed to produce the desired geometry with the desired chemical composition and physio-chemical properties. Specifically, other target criteria, such as, for example, an extrusion pressure, an extrusion speed and/or a shear force upon extrusion, specifically for extrudates, and/or a compaction force, a machine rotation speed and/or an ejection force upon tableting, specifically for tablets, may be considered affecting the productivity, e.g. positively or negatively. Additionally or alternatively, the target criteria may be or may comprise any further criteria, such as for example, a technical criteria, such as a capacity of the shaped body to roll, an economic criteria, such as a market size or a market model, e.g. for a pre-determined group of geometries, a minimum and/or maximum expense, such as a production cost, e.g. a cost model for a pre-determined group of geometries.

In FIG. 5, an embodiment of a shaping tool designing system 170 for designing at least one shaping tool 126 is illustrated in affront plane view. The shaping tool designing system 170 comprises at least one interface 172 configured for retrieving at least one set of shaping target criteria for the shaping tool 126. Further, the shaping tool designing system 170 comprises at least one geometry defining unit 174 configured for defining at least one starting geometry for the shaping tool 126. Further, the shaping tool designing system 170 comprises at least one shaping parameter generating unit 176 configured for generating a set of shaping parameters comprising at least one shape geometry parameter of the starting geometry. Further, the shaping tool designing system 170 comprises at least one simulation unit 178 configured for simulating a shaping process using the shaping tool by varying values of the set of shaping parameters and by comparing simulated shaping properties for these values with the set of shaping target criteria, thereby generating at least one adapted set of shaping parameters for which the shaping target criteria are fulfilled at least within predetermined tolerances. Further, the shaping tool designing system 170 comprises at least one shaping tool geometry defining unit 180 configured for determining at least one geometry of the at least one shaping tool from the adapted set of shaping parameters.

The set of shaping target criteria may comprise a plurality of shaping target criteria, such as a first shaping target criterion Y₁, a second shaping target criterion Y₂, a third shaping target criterion Y₃, and so on. As illustrated in FIG. 5, as an example, the set of shaping target criteria may comprise eight shaping target criterion Y₁ to Y₈. In particular, the shaping target criteria may be weighed. Thus, as further illustrated in FIG. 5, each shaping target criterion Y₁ to Y₈, may be individually weighed, which may be illustrated by an added weight identification β₁ to β₈. In particular, for example when using a multi-criteria optimization, the weight of individual criteria, such as of individual shaping target criterion of the set of shaping target criteria, may be chosen freely, specifically to an extent that within the optimization function an individual shaping target criterion of the set of shaping target criteria may be fully considered, e.g. β=1, or fully discarded, e.g. β=0, or anything in between, e.g. 0<β<1.

As an example, the simulation unit 178 may be configured for simulating a shaping process using the shaping tool 126. In FIG. 5, the simulating a shaping process using the shaping tool 126 may be illustrated by a first box 182 indicating the varying of values of the set of shaping parameters, by a second box 184 indicating the comparing of the simulated shaping properties for these values with the set of shaping target criteria, and by a third box 168 indicating an iterative performance of the simulation by feeding the varied values of the set of shaping parameters back to the first box 182 such as to further vary the values. Thus, as illustrated, in the simulation unit 178, the values of the set of shaping parameters may be varied iteratively until an adapted set of shaping parameters may be found for which the shaping target criteria are fulfilled at least within predetermined tolerances.

In particular, when designing at least one shaping tool 126 with the shaping tool designing system 170, a starting geometry may be described, for example, with geometric parameters. Further, the geometry defining unit 180 may be used for defining the starting geometry, e.g. a shaping tool geometry. The starting geometry may then be evaluated by using the simulation unit 178 for performing simulations according to pre-defined performance criteria, such as by varying values of the set of shaping parameters and by comparing simulated shaping properties for these values with the set of shaping target criteria until an adapted set of shaping parameters is generated for which the shaping target criteria are fulfilled. In detail, as an example, according to the result of the comparison, the values of the set of shaping parameters, e.g. the shaping tool geometric parameters, such as the geometric parameters, may be varied in the simulation, e.g. during an optimization loop, in a way that firstly a new geometry may have a higher probability of fulfilling the pre-defined criteria, e.g. the shaping target criteria, and secondly may reduce simulation resources and time.

Specifically, when designing at least one shaping tool 126 with the shaping tool designing system 170, the properties of the material to be shaped, e.g. a density and/or a viscosity, and/or further the shaping target criteria, such as boundary conditions of the machines used for shaping, e.g. a maximum extrusion pressure and/or a minimum rotation speed of tableting machine, may be taken into consideration.

As an example, the shaping tool designing method 124, may aim at identifying the geometry of shaping tools that allows the shaping of the starting material into the desired geometry, while maintaining the targeted product properties and manufacture productivity. In particular, the shaping tool designing method 124 may be used, as an example, to determine an optimized geometry of the shaping tool, e.g. the die, specifically for new geometries of shaped bodies. Additionally or alternatively, the shaping tool designing method 124 may be used for deriving new geometries of shaping tools for existing shaped bodies.

When simulating the shaping process using the shaping tool 126, for example by using the simulation unit 178, as an example, physical properties of the material to be shaped may need to be estimated and/or measured to be used in the simulation.

The shaping target criteria may, for example, comprise a material property of the material to be shaped. Thus, the shaping target criteria may comprise a viscosity, a powder bulk density, a compressibility, e.g. a compressibility-compactability curve. Additionally or alternatively, the shaping target criteria may, for example, comprise surface properties. In particular, a surface property of the shaping tool 126 may for example directly influence a surface of an object, e.g. of the shaped body 112, manufactured by using that shaping tool 126. Thus, the shaping target criteria may be or may comprise properties of the shaped body 112. In particular, the properties of the shaped body, e.g. a geometry, a weight, a mechanical strength, a porosity or the like, may be estimated from a measured and/or calculated and/or simulated results of a use of the shaping tool 126, e.g. as a shaping tool. Additionally or alternatively, the shaping target criteria may comprise boundary conditions of manufacturing machines, such as a machine geometry, a maximum allowed pressure, a maximum allowed shear force, a maximum allowed compaction force and/or a maximum allowed ejection force.

Additionally or alternatively, the shaping target criteria may be or may comprise a productivity, specifically a minimum and/or a maximum productivity. The productivity may specifically be estimated by using existing data of similar geometries. Additionally or alternatively, the productivity may be calculated and/or simulated by using manufacturing information, e.g. on production machines, such as production lines, and/or on product properties, e.g. product properties which may be needed to produce the desired geometry with the desired chemical composition and physio-chemical properties. Specifically, other shaping target criteria, such as, for example, an extrusion pressure, an extrusion speed and/or a shear force upon extrusion, specifically for extrudates, and/or a compaction force, a machine rotation speed and/or an ejection force upon tableting, specifically for tablets, may be considered affecting the productivity, e.g. positively or negatively. Additionally or alternatively, the shaping target criteria may be or may comprise any further criteria, such as for example, a technical criteria, such as a capacity of the shaped body to roll, an economic criteria, such as a market size or a market model, e.g. for a pre-determined group of geometries, a minimum and/or maximum expense, such as a production cost, e.g. a cost model for a pre-determined group of geometries. In particular, the productivity may be influenced by a geometry of the shaping tool, e.g. of the die, and may thus influence its design.

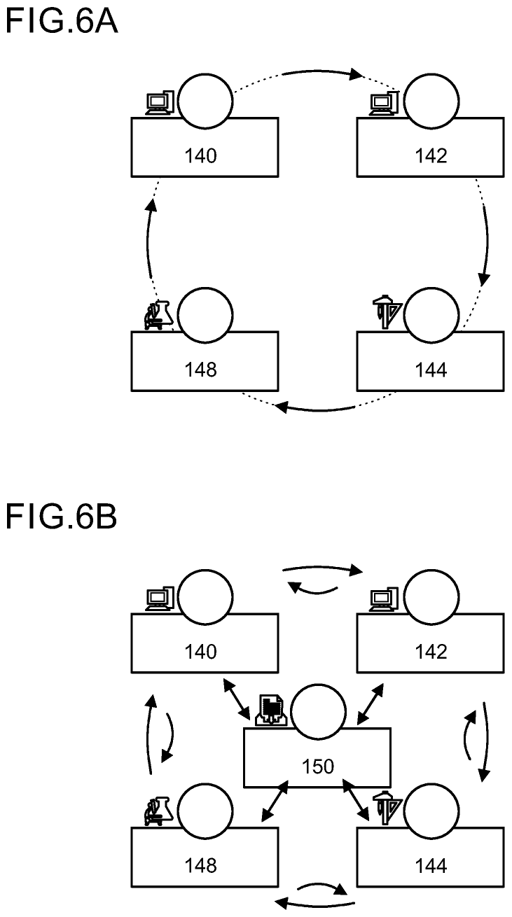

In FIGS. 6A to 6C, flow charts of different embodiments of a method 138 for designing a manufacturing process for manufacturing at least one shaped body 112 are illustrated. Specifically, as indicated by the arrows illustrated in FIG. 6A, step I) 140, step II) 142, step III) 144 and step V) 148 may be performed iteratively, wherein information may be transferred from step I) 140 to step II) 142, from step II) 142 to step III) 144, from step III) 144 to step V) 148 and from step V) 148 to step I) 140. In particular, from step I) 140, as an exemplary output, the lead candidate geometry, such as a geometry of the shaped body, e.g. a drawing of the geometry specifically digital form such as in form of an STL or CAD file, may be transferred as input to step II) 142. Further, from step II) 142, as an exemplary output, a geometry of the shaping tool 126 and/or a negative geometry of an extrusion geometry, e.g. in a digital form such as in a CAD file, and/or a surface quality and/or a surface tension and/or a surface roughness of the shaping tool, may be transferred as input to step III) 144. In particular, the information transferred from step II) 142 to step III) 144 may, for example, influence a material choice, a choice of manufacturing processes and/or a choice of follow-up treatment and/or after treatment, specifically when performing step III). Further, from step III) 144, as an exemplary output, the shaping tool 124 and/or design properties, such as a maximum extrusion pressure or the like, may be transferred as input to step V) 148. Further, from step V) 148, as an exemplary output, a feedback about tests, e.g. properties of the shaped body and/or information on a shaping condition, may be transferred as input to step I) 140.

In particular, step I) 140 and step II) 142 may be performed individually and/or in combination with each other and/or in combination with any one of step III) 144, step IV) 146 (not illustrated) and step V) 148, in order to achieve firstly a lead candidate shape, e.g. an optimized geometry of the shaped body 112, and/or secondly a geometry for the shaping tool, e.g. an optimized geometry of the at least one die. As an example, the illustration of step VI) 150 may show that information may flow from one step to another, such as between any one of steps I) 140 to V) 148. Additionally or alternatively, information could be centralized, such as in a common data lake, wherein information from any of one of steps I) 140 to V) 148 may be centralized and any one of steps I) 140 to V) 148 may be able to access said information. In particular, the information transfer and/or exchange, as illustrated in FIG. 6B, may allow to accelerate a development and may make the process more seamless and transparent, e.g. more transparent to all members. Specifically, step III) 144, step IV) 146 (not illustrated) and step V) 148 may be performed individually and/or in combination with each other or in combination with step I) 140 and/or step II) 142. The method 138 for designing a manufacturing process for manufacturing at least one shaped body 112 may be initiated at any one of steps I) 140, II) 142, III) 144, IV) 146, V) 148 or VI) 150. In particular, each of the steps I) to VI) may provide a usable output.

As an example, the method 138 for designing a manufacturing process for manufacturing at least one shaped body 112 may be applied to shaped bodies such as tablet, extrudate, honeycomb, three-dimensional printed bodies, particles, or any other two-dimensional or three-dimensional structures. The method 138 for designing a manufacturing process for manufacturing at least one shaped body 112 may specifically be configured for designing a manufacturing process for manufacturing a catalyst geometry. However, the method 138 for designing a manufacturing process for manufacturing at least one shaped body 112 may be applied for designing, e.g. optimizing, the geometry of any two-dimensional or three-dimensional object or body.

In particular, as indicated by the arrows illustrated in FIG. 6B, information may also be transferred in both directions, specifically from step I) 140 to step II) 142, from step II) 142 to step III) 144, from step III) 144 to step V) 148 and from step V) 148 to step I) 140 and vice versa. In particular, from step II) 142, as an exemplary output, the geometry of the shaping tool, e.g. a geometric boundary condition of the shaping tool, and/or information on a necessary change in the geometry, e.g. information on the change of at least one wall thickness, may be transferred as input to step I) 140. As an example, information on how to operate a shaping machine used for processing the at least one shaped body 112, e.g. having the targeted geometry, may be transferred from step II) 142 to step V) 148. As a further example, information on the experimental validation, e.g. feedback information, may be transferred from step V) 148 to step II) 142. Further, from step III) 144, as an exemplary output, an available space for a geometry of the shaping tool 126 and/or a technical drawing of the shaping tool 126, e.g. a CAD model and/or a surface quality and/or a boundary condition of a construction, e.g. of a construction used in a prototyping process, may be transferred as input to step II) 142. Further, from step V) 148, as an exemplary output, a boundary condition of the shaping tool, e.g. of a die, such as for example a minimum and/or maximum pressure, and/or a characteristic of a machine used for shaping, such as a geometry of a shaping tool plate, and/or an error message, such as information on a high abrasion and/or information on a molding of the extrudate, may be transferred as input to step III) 144. In particular, the information transferred from step V) 148 to step III) 144 may, for example, influence a choice to adapt a surface, e.g. a surface of the shaping tool 126, and/or to improve a typology in order to adapt a flow characteristic, specifically when performing step III). Further, from step I) 140, as an exemplary output, a predicted property of the shaped body and/or information on which properties were optimized and/or the set of target criteria, may be transferred as input to step V) 148.

Additionally or alternatively, as further illustrated in FIG. 6B, information may be transferred between all the steps by performing step VI) 150. In particular, from step II) 142, as an exemplary output, a predicted experimental setting, e.g. an extrusion speed and/or an extrusion pressure, and/or information on a velocity profile across the shaping tool 126, e.g. Information on a simulated velocity of the paste across the shaping tool 126, may be transferred as input to step V) 148. Further, from step V) 148, as an exemplary output, a viscosity of the material to be shaped, e.g. a paste viscosity, and/or information on an outcome of experiments with simple geometries, e.g. a pressure and/or a throughput, may be transferred as input to step II) 142. Further, from step I) 140, as an exemplary output, a lead candidate geometry, e.g. a geometry of the shaped body, such as an optimized geometry for example including a weight, and/or a quality of a property of the shaped body, e.g. a twist, may be transferred as input to step III) 144. Further, from step III) 144, as an exemplary output, a geometric boundary condition of the shaping tool, e.g. of the die, such as for example a specific file format, may be transferred as input to step I) 140.

As an example, and output of either one of steps I) 140, II) 142 and/or step V) 148 may be automatically used in step III) 144, e.g. to generate at least one technical drawing, at least one three dimensional models and/or to specify a manufacturing of the shaping tool 126, e.g. of the shaping tool. Further, specifically in order to allow automatic use, a machine learning algorithm, an artificial intelligence and/or an neural network may be used.

Specifically, as indicated by the further arrows illustrated in FIG. 6C, information may also be input into and/or output from each of step I) 140, step II) 142, step III) 144 and step V) 148. In particular, the input and/or output information, such as input and/or output, of each step may for example be gathered individually. Additionally or alternatively, the inputs and outputs of each step may be gathered in a central database. As an example, the inputs and outputs may be formatted in a standard report format, such as to facilitate documentation and comparison. Additionally or alternatively, the inputs and outputs may be or may comprise at least one technical file, such as at least one computer-aided design (CAD) drawing, a technical drawing and/or a technical specification. In detail, the input and/or output may be gathered and/or generated for each individual step. Additionally or alternatively, the input and/or output may be gathered and/or generated for any combination of steps, and even for a combination of all the method steps. Specifically, the input and/or output may be gathered and/or generated after each interaction between steps and/or after an overall target of the method may be fulfilled.

In detail, input information, such as general input information, for step I) 140, e.g. an input information from a need owner into step I) 140, for example, may be or may comprise one or more of: a seed geometry; an input required for each target criterion, such as a material property, e.g. a catalyst material property and/or a Young module, and/or an application condition, such as a reactor geometry, e.g. a reactor diameter, and/or a reactor temperature; a multi-criteria optimization function; a simulation tool to be used in the simulation, such as a nonlinear algorithm, a stochastic algorithm, a genetic algorithm, an artificial intelligence and/or a neural network; a weight of at least one target criterion of the set of target criteria, e.g. for use in the multi-criteria optimization function; the set of target criteria. An output information from step I), e.g. an output information from step I) 140 to a need owner, for example, may be or may comprise one or more of: a report comprising information on the shaped body 112, e.g. a report containing a description of the optimized geometry; at least one property of the shaped body 112, e.g. a property of the lead candidate geometry; a comparison between different geometries for the shaped body; a list of options; a best option. In particular, information on the shaped body 112 may exist in a technical file, such as in a CAD-file and/or CAD-drawing.

Further, input information, such as general input information, for step II) 142, e.g. an input information from a need owner into step II) 142, for example, may be or may comprise one or more of: a desired extrusion speed; a rheology of the material to be shaped, e.g. a rheology of the paste. An output information from step II) 142, e.g. an output information from step II) 142 to a need owner, for example, may be or may comprise a documentation of simulations, e.g. a simulated velocity profile in the shaping tool 126 and/or a velocity profile along the shaping tool 126 and/or further information, such as at least one picture As a further example, the output information from step II) may be or may comprise information on predicted settings of the shaping machine, such as an extrusion pressure, a tableting compression force, a throughput, or the like.

Further, input information, such as general input information, for step III) 144, e.g. an input information from a need owner into step III) 144, for example, may be or may comprise one or more of: a boundary condition for the shaping tool 126, e.g. of at least one die, e.g. the geometry of the shaping tool 126; a prototyping information, e.g. a pressure; a requirement, such as a material requirement, e.g. for minimizing a corrosion. An output information from step III) 144, e.g. an output information from step III) 144 to a need owner, for example, may be or may comprise one or more of: the shaping tool 126, e.g. a prototyped die; a technical documentation, such as a technical drawing and/or a technical model.

Further, input information, such as general input information, for step V) 148, e.g. an input information from a need owner into step V) 148, for example, may be or may comprise one or more of: a material information, specifically a material combination, e.g. a material recipe, such as a recipe to be tested: a mechanical information on the shaped body and/or on the shaping tool, specifically a stability of the catalyst; an information on a sensitivity of the shaped body and/or of the shaping tool to production parameters; information on which experiments have been conducted; information on analytic parameters, specific on required analytical parameters; information on the safety aspect of at least one experiment. An output information from step V) 148, e.g. an output information from step V) 148 to a need owner, for example, may be or may comprise one or more of: a behavior upon shaping the shaped body 112 with the shaping tool 126, e.g. an extrusion pressure versus a speed; an evaluation of the shaped body 112 and/or the shaping tool 126, e.g. of the optimized geometry, such as an evaluation of the optimized geometry using analytic parameters.

In particular, the manufacturing process for manufacturing at least one shaped body 112 may be configured for fulfilling at least one need. In particular the need may, for example, be a combination of the target criteria of the designing method 110 and the shaping target criteria of the shaping tool designing method 124.

In particular the at least one need to be fulfilled by the manufacturing process for manufacturing at least one shaped body 112 may be considered in the manufacturing process designing method 138. Thus in particular, the need, e.g. a combination of the target criteria and the shaping target criteria, may be identified based on at least one consideration of one or more of: a technology available for the manufacturing process; a cost, such as a production cost for the shaped body 112 and/or for the shaping tool 126; a market. In particular, the target criteria may be or may comprise one or more of: a maximum and minimum allowed pressure drop; target productivity in tons/day; or the like. Specifically, the shaping target criteria may be or may comprise one or more of: a maximum allowed extrusion pressure; maximum allowed rotation speed of tableting machine; or the like. Further, both the target criteria and the shaping target criteria, for example a boundary condition for the simulations and optimizations, of step I) 140 and step II) 142, may further be relevant for performing step III) 144 and may specifically be or may comprise one or more of: an extrusion constraint, such as a maximum diameter of extrusion die; a tableting constraint, such as a maximum tablet height; a shaping constraint, such as a genera boundary of the shaping process.

As an example, a designing of the manufacturing process may specifically depend on the target criteria for the shaped body 112, such as on at least one required property of the shaped body. In particular, a geometry, e.g. a shape, and/or a material of the shaped body may determine the selection. In particular for complex shapes, new manufacturing technologies, such as for example, additive manufacturing, may be used. Dependent on the application, as an example, the additively manufactured parts may receive a finishing, such as a final treatment in order to smoothen the surface of the part. Thus, in case the shaping tool 126 may be prototyped or manufactured by using an additive manufacturing process, its surface may receive a finishing, e.g. a treatment in order to smoothen the surface. As an example, for finishing the surface of the shaping tool 126 one or more of the following technologies may be used: Electro Polishing, Plasma Polishing, Laser Polishing, Tumbling, Blasting, Hydro Erosive Grinding and MMP (Micro Machining Process).

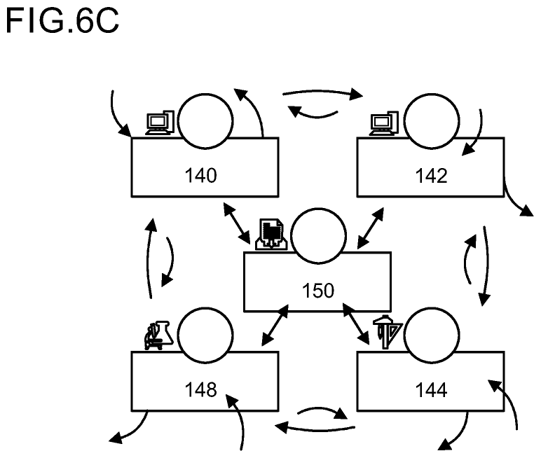

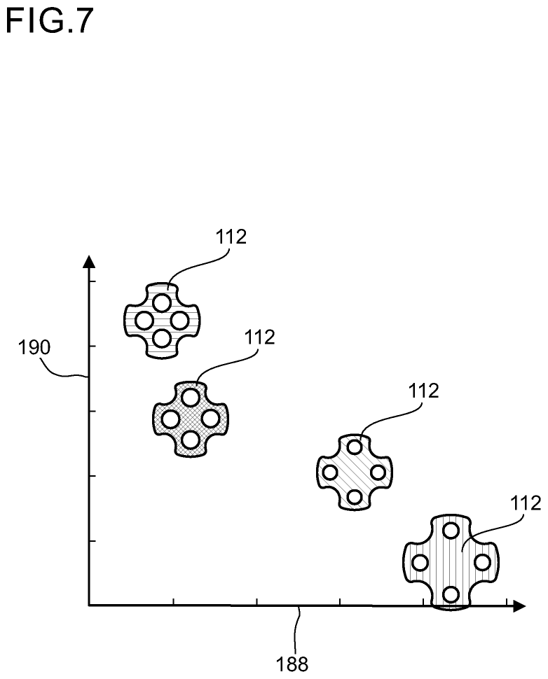

In FIG. 7 different embodiments of a shaped body 112 are illustrated. Specifically, the shaped bodies 112 may be arranged in a diagram according to at least one characteristic of each of the shaped bodies 112. In particular, as an example, the x-axis may refer to a side crushing strength 188 of the shaped bodies 112 and the y-axis may refer to a specific reactor surface area 190 of the shaped bodies 112.

In FIG. 8A, an embodiment of a shaped body 112 is illustrated in a perspective view. In FIG. 8B an embodiment of a shaping tool 126 for manufacturing the shaped body 112 illustrated in FIG. 8A, is shown. The arrow indicates a direction of flow of a material through the shaping tool 126 illustrated in FIG. 8A.

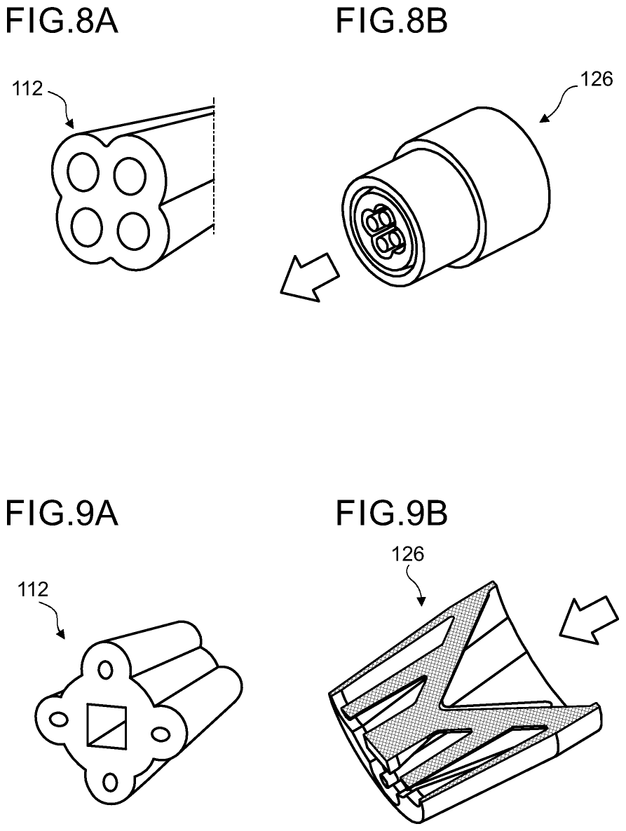

In FIG. 9A, an embodiment of a shaped body 112 is illustrated in a perspective view. In FIG. 9B section view of an embodiment of a shaping tool 126 for manufacturing the shaped body 112 illustrated in FIG. 9A, is shown. Again, the arrow indicates a direction of flow of a material through the shaping tool 126 in order to manufacture the respective shaped body 112.

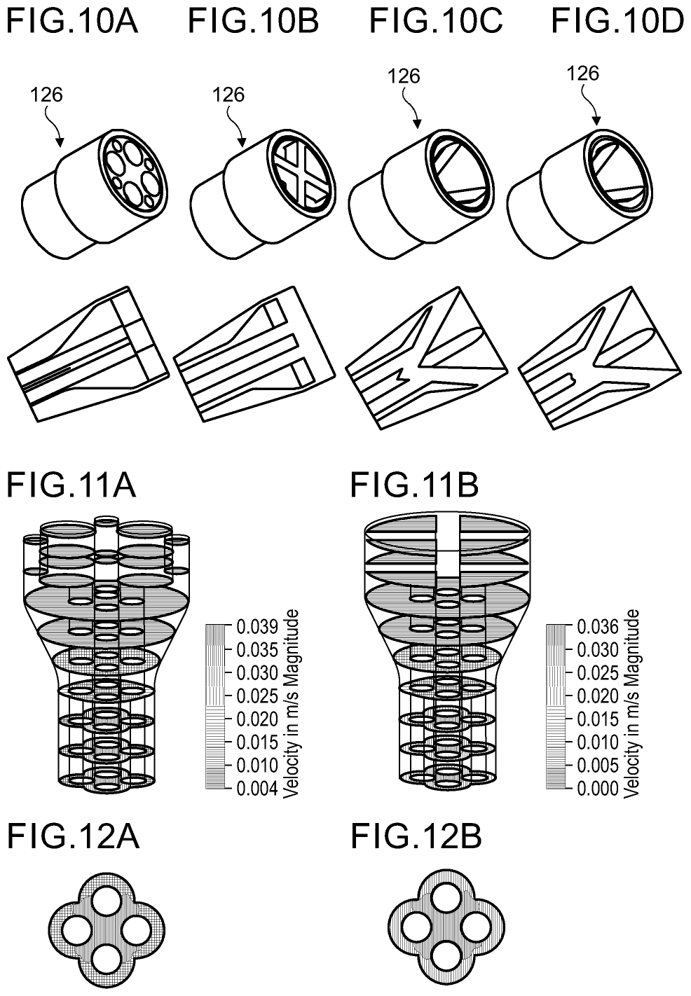

In FIGS. 10A to 10D, different embodiments of a shaping tool 126 are illustrated, each in a perspective view above and in a section view below. Specifically, a development of the geometry of the shaping tool 126 when simulating a shaping process using the shaping tool 126 in step iv) may be illustrated, wherein the shaping tool 126 illustrated in FIG. 10A may show the starting geometry and the shaping tool 126 illustrated in FIG. 10D may show the geometry of the shaping tool 126 determined from the adapted set of shaping parameters.

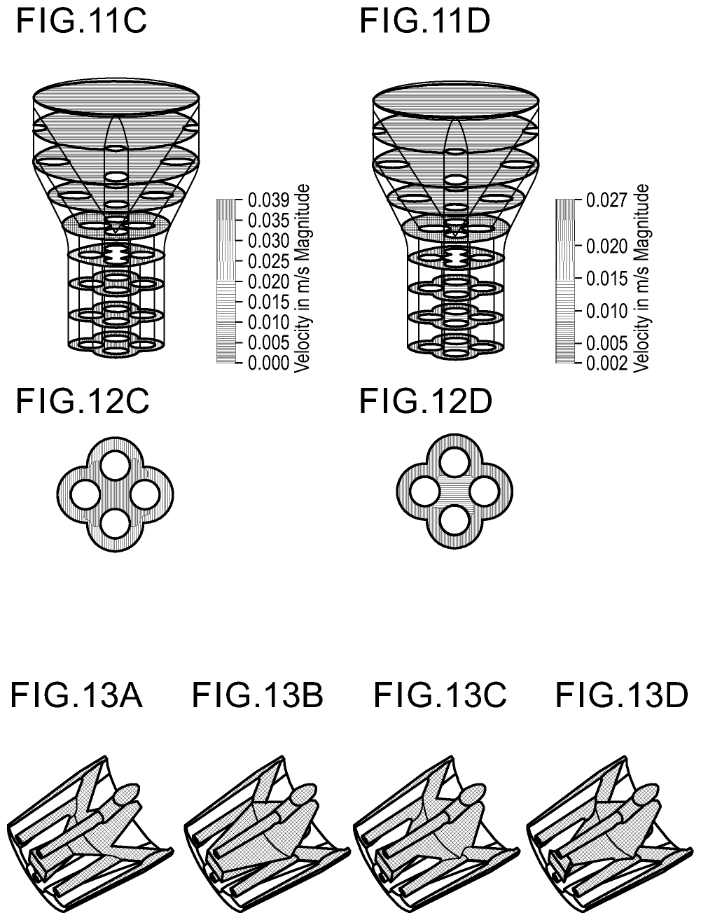

In FIGS. 11A to 11D, different embodiments of a shaping tool 126 are shown in a perspective view and in FIGS. 12A to 12D different embodiments of a shaped body 112 manufactured by respectively using the shaping tools 126 illustrated in FIGS. 11A to 11D are illustrated. Specifically, FIGS. 11A to 12D may illustrate a simulation as conducted, for example, in step II) 142.

In FIGS. 13A to 13D different embodiments of a shaping tool 126 are shown in a section view, wherein, again, a development of the geometry of the shaping tool 126 when simulating a shaping process using the shaping tool 126 in step iv) may be illustrated.

### LIST OF REFERENCE NUMBERS

110 designing method
112 shaped body
114 step a)
116 step b)
118 step c)
120 step d)
122 step e)
124 shaping tool designing method
126 shaping tool
128 step i)
130 step ii)
132 step iii)
134 step iv)
136 step v)
138 manufacturing process designing method
140 step I)
142 step II)
144 step III)
146 step IV)
148 step V)
150 step VI)
152 designing system
154 interface
156 geometry defining unit
158 parameter generating unit
160 simulation unit
162 lead candidate geometry defining unit
164 first box
166 second box
168 third box
170 shaping tool designing system
172 interface
174 geometry defining unit
176 shaping parameter generating unit
178 simulation unit
180 shaping tool geometry defining unit
182 first box
184 second box
186 third box
188 side crushing strength

1. A computer-implemented method for designing at least one shaped body, wherein the shaped body is one or more of a catalyst pellet and an adsorbent pellet, the method comprising:
a) retrieving, by using at least one interface, at least one set of target criteria for the shaped body;
b) defining, by using at least one geometry defining unit, at least one seed geometry for the shaped body, wherein the seed geometry is a starting geometry for the shaped body, wherein step b) comprises a sub-step of providing the seed geometry to at least one processor of the computer on which the computer-implemented method is performed;
c) generating, by using at least one parameter generating unit, a set of parameters comprising at least one geometry parameter of the seed geometry, wherein step c) comprises a sub-step of providing the set of parameters to at least one processor of the computer on which the computer-implemented method is performed;
d) simulating, by using at least one simulation unit, the shaped body by varying values of the set of parameters and by comparing simulated criteria for these values with the set of target criteria, thereby generating at least one adapted set of parameters for which the target criteria are fulfilled at least within predetermined tolerances, wherein simulating the shaped body is an optimization process and wherein the adapted set of parameters refers to an adapted set of values of parameters; and
e) determining, by using at least one lead candidate geometry defining unit, at least one lead candidate geometry of the at least one shaped body from the adapted set of parameters, wherein the lead candidate geometry is the resulting geometry for the shaped body.

2. The method according to claim 1, wherein the target criteria contain at least one constraint selected from the group consisting of: a geometry constraint, such as a production machine tolerance, a wall minimum thickness, a tabletability constraint, an extrudability constraint, a maximum diameter constraint, a maximum height constraint; a weight constraint; a surface area constraint; a density constraint; a mechanical strength constraint; a pressure drop constraint; a heat transport constraint; a mass transport constraint; a productivity constraint; a shaping process constraint.

3. The method according to claim 1, wherein at least one of the target criteria of the set of target criteria comprises at least one condition to be fulfilled by the shaped body.

4. The method according to claim 1, wherein the target criteria comprise at least one suitability of the shaped body for at least one predetermined application purpose.

5. The method according to claim 1, wherein the adapted set of parameters in step d) is generated by applying at least one operation selected from the group consisting of: a non-linear algorithm; a stochastic algorithm; a genetic algorithm; an artificial intelligence algorithm; a gradient-based algorithm; a multi-criteria optimization function; sequential quadratic programming; method of feasible directions; quasi-newton method; newton method.

6. The method according to claim 1, further comprising a computer-implemented designing of at least one shaping tool for manufacturing the shaped body, the computer-implemented method for designing the at least one shaping tool comprising:
i) retrieving, by using at least one interface, at least one set of shaping target criteria for the shaping tool;
ii) defining, by using at least one geometry defining unit, at least one starting geometry for the shaping tool, wherein at least one negative geometry of the at least one lead candidate geometry determined in step e) is used as the starting geometry;
iii) generating, by using at least one shaping parameter generating unit, a set of shaping parameters comprising at least one shape geometry parameter of the starting geometry;
iv) simulating, by using at least one simulation unit, a shaping process using the shaping tool by varying values of the set of shaping parameters and by comparing simulated shaping properties for these values with the set of shaping target criteria, thereby generating at least one shaping geometry with an adapted set of shaping parameters for which the shaping target criteria are fulfilled at least within predetermined tolerances; and
v) determining, by using at least one shaping tool geometry defining unit, at least one geometry of the at least one shaping tool from the adapted set of shaping parameters.

7. The method according to claim 6, wherein the shaping target criteria comprise at least one suitability of the shaping tool for shaping the at least one shaped body, specifically the shaped body with the lead candidate geometry determined in step e).

8. The method according to claim 6, wherein the shaping target criteria contain at least one constraint selected from the group consisting of: a surface property constraint; a geometry constraint; a pressure constraint; a shear force constraint; a compaction force constraint; an ejection force constraint; a productivity constraint; a force distribution constraint; a velocity distribution constraint; a mechanical stability constraint; a strength constraint, such as a tensile strength constraint; a pore size constraint; a weight constraint; an attrition performance constraint; a production machine constraint; a production constraint.

9. The method according to claim 6, wherein at least one of the shaping target criteria of the set of shaping target criteria comprises at least one condition to be fulfilled by the shaping tool.

10. The method according to claim 6, wherein the adapted set of parameters in step iv) is generated by applying at least one operation selected from the group consisting of a non-linear algorithm; a stochastic algorithm; a genetic algorithm; an artificial intelligence algorithm; a gradient-based algorithm; a multi-criteria optimization function; sequential quadratic programming; method of feasible directions; quasi-newton method; newton method.

11. (canceled)

12. A process for the production of a shaped body having a lead candidate geometry designed according to the computer-implemented method for designing at least one shaped body according to claim 1.

13. A computer-implemented method for designing a manufacturing process for manufacturing at least one shaped body, the method comprising:
I) designing the shaped body by using the method according to claim 1 referring to a method for designing at least one shaped body, thereby determining at least one lead candidate geometry of the shaped body; and
II) designing at least one shaping tool for manufacturing the shaped body by using a computer-implemented method for designing at least one shaping tool, the computer-implemented method for designing the at least one shaping tool comprising:
i) retrieving at least one set of shaping target criteria for the shaping tool;
ii) defining at least one starting geometry for the shaping tool, wherein at least one negative geometry of the at least one lead candidate geometry determined in step I) is used as the starting geometry;
iii) generating a set of shaping parameters comprising at least one shape geometry parameter of the starting geometry;
iv) simulating a shaping process using the shaping tool by varying values of the set of shaping parameters and by comparing simulated shaping properties for these values with the set of shaping target criteria, thereby generating at least one shaping geometry with an adapted set of shaping parameters for which the shaping target criteria are fulfilled at least within predetermined tolerances; and
v) determining at least one geometry of the at least one shaping tool from the adapted set of shaping parameters;
III) prototyping the at least one shaping tool from at least one geometry of the shaping tool designed in step II), wherein at least one process is used, wherein the process is selected from the group consisting of: a rapid prototyping process, specifically an additive manufacturing process, more specifically one or more of a 3D printing process or an additive layer manufacturing process; a conventional prototyping process, e.g. a subtractive prototyping process; a spark erosion process.

14. The method according to claim 13, wherein the shaping target criteria comprise at least one suitability of the shaping tool for shaping at least one predetermined object, wherein the predetermined object is the shaped body designed by using the method according to any one of the preceding claims referring to a method for designing at least one shaped body.

15. The method according to claim 13, wherein the shaping target criteria contain at least one constraint selected from the group consisting of: a surface property constraint; a geometry constraint; a pressure constraint; a shear force constraint; a compaction force constraint; an ejection force constraint; a productivity constraint; a force distribution constraint; a velocity distribution constraint; a mechanical stability constraint; a strength constraint, such as a tensile strength constraint; a pore size constraint; a weight constraint; an attrition performance constraint; a production machine constraint; a production constraint.

16. The method according to claim 13, wherein at least one of the shaping target criteria of the set of shaping target criteria comprises at least one condition to be fulfilled by the shaping tool.

17. The method according to claim 13, wherein the adapted set of parameters in step iv) is generated by applying at least one operation selected from the group consisting of a non-linear algorithm; a stochastic algorithm; a genetic algorithm; an artificial intelligence algorithm; a gradient-based algorithm; a multi-criteria optimization function; sequential quadratic programming; method of feasible directions; quasi-newton method; newton method.

18. The method according to claim 13, wherein the method of step II) further comprises:
vi) prototyping the at least one shaping tool from the at least one geometry of the shaping tool determined in step v); and
vii) validating the prototyped shaping tool by comparing at least one property of the prototyped shaping tool with at least one property of a simulated shaping tool.

19. The method according to claim 13, wherein the method further comprises:
IV) manufacturing the at least one shaped body from the prototyped shaping tool; and
V) experimentally validating one or more of the shaped body and the shaping tool.

20. (canceled)

21. A designing system for designing at least one shaped body, wherein the shaped body is one or more of a catalyst pellet and an adsorbent pellet, the designing system comprising:
A. at least one interface configured for retrieving at least one set of target criteria for the shaped body;
B. at least one geometry defining unit configured for defining at least one seed geometry for the shaped body, wherein the seed geometry is a starting geometry for the shaped body;
C. at least one parameter generating unit configured for generating a set of parameters comprising at least one geometry parameter of the seed geometry;
D. at least one simulation unit configured for simulating the shaped body by varying values of the set of parameters and by comparing simulated criteria for these values with the set of target criteria, thereby generating at least one adapted set of parameters for which the target criteria are fulfilled at least within predetermined tolerances, wherein simulating the shaped body is an optimization process and wherein the adapted set of parameters refers to an adapted set of values of parameters; and
E. at least one lead candidate geometry defining unit configured for determining at least one lead candidate geometry of the at least one shaped body from the adapted set of parameters, wherein the lead candidate geometry is the resulting geometry for the shaped body.

22. A manufacture-designing system for designing a manufacturing process for manufacturing at least one shaped body, the manufacture-designing system comprising the designing system according to claim 21 and at least one shaping tool designing system for designing at least one shaping tool, the shaping tool designing system comprising:
u. at least one interface configured for retrieving at least one set of shaping target criteria for the shaping tool;
v. at least one geometry defining unit configured for defining at least one starting geometry for the shaping tool;
w. at least one shaping parameter generating unit configured for generating a set of shaping parameters comprising at least one shape geometry parameter of the starting geometry;
x. at least one simulation unit configured for simulating a shaping process using the shaping tool by varying values of the set of shaping parameters and by comparing simulated shaping properties for these values with the set of shaping target criteria, thereby generating at least one adapted set of shaping parameters for which the shaping target criteria are fulfilled at least within predetermined tolerances; and
y. at least one shaping tool geometry defining unit configured for determining at least one geometry of the at least one shaping tool from the adapted set of shaping parameters.
